(19) United States
(12) Patent Application Publication
(10) Pub. No.: US 2022/0212163 A1
(43) Pub. Date: Jul. 7, 2022

(54) CHABAZITE-TYPE ZEOLITE, PRECURSORS THEREOF, METHODS FOR MAKING THE SAME AND USE OF THE ZEOLITE AS SORBENT FOR CO2

(71) Applicant: TOTAL SE, Courbevoie (FR)

(72) Inventors: Nicolas BARRIER, Caen (FR); Philippe BOULLAY, IFS (FR); Jean-Pierre GILSON, Cairon (FR); Julien GRAND, Viroflay (FR); Delphine MINOUX, Nivelles (BE); Svetlana MINTOVA, Basly (FR); Nikolai NESTERENKO, Nivelles (Thines) (BE); Maxime DEBOST, Courbevoie (FR)

(21) Appl. No.: 17/617,211

(22) PCT Filed: May 20, 2020
(86) PCT No.: PCT/EP2020/064168

§ 371 Date: Dec. 7, 2021

(30) Foreign Application Priority Data
Jun. 21, 2019 (EP) 19315046.3
Jun. 21, 2019 (EP) 19315047.1

(51) Int. Cl. B01J 20/18; B01J 20/28; B01J 20/30; C01B 39/46

(52) U.S. Cl. CPC B01J 20/186; B01J 2220/42; B01J 20/28011; B01J 20/28059; B01J 20/28061; B01J 20/28071; B01J 20/3085; C01B 39/46; C01P 2002/60; C01P 2002/86; C01P 2004/45; C01P 2004/62; C01P 2004/64; C01P 2006/12; C01P 2006/14; B01J 20/28007

(57) ABSTRACT

The present disclosure relates to a chabazite-type zeolite, comprising at least two cages composed of 4- and 8-membered rings connected by one 6-membered double ring, remarkable in that it has a Si/Al molar ratio comprised between 1 and 15, in that it comprises caesium and potassium with a Cs/K molar ratio of at most 5.0 and in that it forms nanoparticles with an average crystal size comprised between 5 nm and 250 nm and with a specific surface area comprised between 50 m²g⁻¹ and 200 m²g⁻¹. Amorphous precursors, devoid of an organic structure-directing agent, as well as a method for preparation of these amorphous precursors in the absence of such organic structure-directing agent and method for preparation of the chabazite-type zeolite, are also described. Finally, the use of the chabazite-type zeolite as a sorbent for carbon dioxide is also demonstrated.

### TECHNICAL FIELD

The present disclosure deals with a new synthesis route of template-free, seeds-free and fluoride-free discrete nanosized chabazite-type zeolites. The present disclosure also deals with the use of the nanosized chabazite-type zeolites as a sorbent for carbon dioxide.

### TECHNICAL BACKGROUND

Zeolites are structurally complex inorganic polymers with a three-dimensional crystalline skeleton of TO₄ tetrahedral. The centre of the tetrahedral is generally a silicon or aluminium atom, which corresponds to a SiO₄ and AlO₄ tetrahedron respectively. These tetrahedral are connected by common oxygen atoms. The complete structure forms a three-dimensional network, exhibiting some micropores, cages and channels.

The chabazite-type zeolites (CHA) possess a super cage (10 Å×8 Å×8 Å) interconnected by a three-dimensional pore system with 8-membered rings doors (3.8 Å×3.8 Å). This zeolite is well-known for its uses in the methanol-to-olefins (MTO) process as shown in the study entitled “Organic-Free Synthesis of CHA-Type Zeolite Catalysts for the Methanol-to-Olefins Reaction” by J. Ji et al. (ACS Catal., 2015, 5, 4456-4465]). F. Gao et al., in the study entitled “Current Understanding of Cu-Exchanged Chabazite Molecular Sieves for Use as Commercial Diesel Engine DeNOₓ Catalysts” (Top. Catal., 2013, 56, 1441-1459), demonstrated the excellent application of CHA for selective catalytic reduction (SCR) reaction. This material has found a promising application in the CO₂/CH₄ separation according to the study entitled “Scale-up of SAPO-34 membranes for CO₂/CH₄ separation” of S. Li et al. (J. Membrane Sci., 2010, 352, 7-13). The separation ability is higher with the aluminosilicate CHA-type zeolite with a Si/Al molar ratio lower than 3 due to a phenomenon named “Trap Door effect”. Shang et al., in the study entitled “Site Preferences in the Mixed Cation Zeolite, Li,Na-Chabazite: A Combined Solid-State NMR and Neutron Diffraction Study” (J. Am. Chem. Soc., 2012, 134, 19246-19253), demonstrated that CO₂ and CO molecules can enter the cage of the CHA zeolite by deviating the door-keeping cations (K⁺, Rb⁺, Cs⁺) while the non-polar molecule CH₄ cannot. This allows CO₂ and CH₄ to be separated from a mixture.

The molecular trapdoor was also studied in Jin Shang et al. “Determination of Composition Range for “Molecular Trapdoor” Effect in Chabazite Zeolite” Journal of Physical Chemistry C, vol. 117, No. 24 (2013) 12841-12847; and in Jin Shang et al. “Discriminative Separation of Gases by a “Molecular Trapdoor” Mechanism in Chabazite Zeolites” Journal of the American Chemical Society, vol. 134, No. 46 (2012) 19246-19253.

The first synthesis of aluminosilicate CHA zeolite (SSZ-13) has been performed by S. I. Zones in 1985 (see U.S. patent application Ser. No. 4,544,538) using organic-structure-directing agents N,N,N-trimethyladamantammonium hydroxide (TMAdaOH) coupled with OH⁻ as a mineralizing agent. This method requires a calcination step of expensive and unrecyclable organic compounds. Cao et al. (in U.S. Pat. No. 7,754,187) reported in 2008 the use of N,N,N-dimethylethylcyclohexyl ammonium. Ren et al., in the study entitled “Designed copper-amine complex as an efficient template for one-pot synthesis of Cu-SSZ-13 zeolite with excellent activity for selective catalytic reduction of NOₓby NH₃” (Chem. Commun., 2011, 47, 9789-9791) reported the use of tris[2-(2-pyridyl)ethyl]amine copper (II) complex (Cu²+-TEPA) for directing CHA-synthesis.

M. Bourgogne et al. (in U.S. Pat. No. 4,503,024) proposed in 1983 to transform FAU to CHA under alkaline conditions. This transformation was widely studied for recrystallization of the H-FAU zeolite in the presence of KOH to obtain CHA zeolite with a Si/Al molar ratio between 2 to 11. It is interesting to note that T. M. Davis (in U.S. Patent 2014/0010754) and Van Tendeloo L. et al., in the study entitled “Alkaline cations directing the transformation of FAU zeolites into five different framework types” (Chem. Commun., 2013, 49, 11737-11739), have also used H-LEV and Na-FAU, respectively as starting material toward transformation to CHA zeolite.

H. H mai et. al., in the study entitled “Direct crystallization of CHA-type zeolite from amorphous aluminosilicate gel by seed-assisted method in the absence of organic-structure-directing agents” (Micropor. Mesopor. Mater., 2014, 196, 341-348), have proposed another method of CHA synthesis using a seed approach. This method consists of the synthesis of CHA zeolites without an organic template but with the addition of large amounts of classically prepared SSZ-13 seeds (20 wt. %).

B. Liu et al., in the study entitled “Synthesis of low-silica CHA zeolite chabazite in fluoride media without organic structural directing agents and zeolites” (Micropor. Mesopor. Mater., 2014, 196, 270-276) were the first to propose an OSDA-free (OSDA standing for “organic structure-directing agent) and seed-free method for the CHA synthesis by using NH₄F. This method limits the defects of the zeolite and gives micron-sized crystals (more than 15 μm). As a result, the materials showed low efficiency for gas adsorption or in catalytic applications.

Nanosized CHA has been synthesized by Z. Li et al., in the study entitled “Synthesis of nano-SSZ-13 and its application in the reaction of methanol to olefins” (Catal. Sci. Technol., 2016, 6, 5856-5863), by using trimethyl-1-adamantanammonium and a molecular surfactant hexadecyl trimethyl ammonium bromide. The other methods used for direct synthesis of nanosized CHA combine few regular approaches: M. Zhou et al., in the study entitled “Facile Preparation of Hydrophobic Colloidal MFI and CHA Crystals and Oriented Ultrathin Films”, (Angew. Chem. Int. Ed., 2018, 57, 10966-10970] used fluoride compound and OSDA, while T. Takata et al., in the study entitled “Nanosized CHA zeolites with high thermal and hydrothermal stability derived from the hydrothermal conversion of FAU zeolite” (Micropor. Mesopor Mater, 2016, 225, 524-533), combined FAU recrystallisation, seed and OSDA to synthesis nanosized CHA.

Reduction of the particle size of CHA by ball milling was reported by C. Anand et al., in a study entitled “Downsizing the K-CHA zeolite by a postmilling-recrystallization method for enhanced base-catalytic performance” (New J. Chem., 2016, 40, 492-496).

S. Mintova et al., in a study entitled “Nanosized microporous crystals: emerging applications” (Chem. Soc. Rev., 2015, 44, 7207-7233), demonstrated that it is important to decrease the size of the crystals of zeolites to substantially reduce gas diffusion limitations. Thus, the preparation of nanosized discrete crystals allows increasing the surface/bulk ratio and improving the ad/desorption kinetics.

European patent EP 2 368 849 published in 2011 describes a chabazite-type zeolite having a Si/Al molar ratio ranging between 15 and 50 in which the crystal has an average particle diameter of at least 1.5 pm as measured by scanning electron microscope (SEM). A process for making such chabazite-type zeolite is also described and employs a structure-directing agent, such as a N,N,N-trimethyladamantyl ammonium derivatives.

U.S. Pat. No. 9,889,436 published in 2012 describes a chabazite-type zeolite having a Si/Al molar ratio inferior to 15 in which the crystal has an average particle size ranging between 1.0 μm and 2.67 μm. The crystal is dispersed as rhombohedral or cuboidal particles. A process for making such chabazite-type zeolite is also described and employs a structure-directing agent based on N,N,N-trimethyladamantyl ammonium derivatives, N,N,N-trimethylbenzyl ammonium derivatives, N,N,N-trialkylexoaminonorbornane derivatives or N-alkyl-3-quinuclidinol derivatives.

In the patent numbered US 2016/0101415, published in 2016, the synthesis of a zeolite having the chabazite framework without the use of an organic structure-directing agent has been reported. The crystallized product, which has an 8-membered ring channel, shows a microporous region and a mesoporous region with a micropore volume comprised between 0.03 cm³ g⁻¹ and 0.8 cm³ g⁻¹ of the composition, as determined by analysis of Ar sorption isotherms.

In the study entitled “Sorption of carbon dioxide, methane and nitrogen on zeolite-F: Equilibrium adsorption study”, by Belani M. R. et al. (Environmental Progress & Sustainable Energy, 2017, 36 (3), 850-856), the use of a zeolite from the EDI framework, zeolite-F, with a size of the micrometric range, synthesized from the batch composition 3 SiO₂:1.0 Al₂O₃:5.26 K₂O:94.5 H₂O and thus without an organic template, revealed, at a temperature of 303 K (29.85° C.) and a pressure of 850 mmHg (1.13 bar), high selectivity for carbon dioxide in comparison to methane (CO₂/CH₄=30) and nitrogen gas (CO₂/N₂=38). At those conditions, the CO₂ uptake by the zeolite-F was measured to be of 1.869 mmol/g.

Yang Xiaobo et al. “High silica zeolite Phi, a CHA type zeolite with ABC-D6R stacking faults” Microporous and Mesoporous material, 248 (2017) 129-138 elaborates a method to synthesize CHA zeolites with Si/Al ratios in a wide range, through adding some weak bases to modify the crystallization kinetics in favour of the desired CHA framework. Several organic and inorganic bases are feasible for this purpose. Pure crystalline CHA materials with Si/Al=2-30 have been obtained.

Bo Liu et al. “Preparation of CHA zeolite (chabazite) crystals and membranes without organic structural directing agents for CO₂ separation” Journal of membrane science, vol. 573, 24 (2018) 333-343. This study discloses the preparation of CHA zeolite (chabazite) crystals and membranes from organic structural directing agents-free (OSDA-free) gels. Chabazite membranes were grown on the tubular alumina supports. The effect of caesium and fluoride salts on the crystallization of chabazite crystals and membranes were investigated. Highly crystalline chabazite and uniform chabazite membranes were only obtained from the gel containing the caesium and fluoride salts.

Golubeva O Yu et al. “Study of the influence of extra-framework cations and organic templates on zeolite crystallization in SiO₂—Al₂O₃—Na₂O—K₂O (R₂O, RO) systems” Glass Physics and Chemistry, vol. 42 No. 6 (2016) 566-575 describes the preparation of CHA zeolite using a template.

EP0391351 describes a process for preparing a synthetic chabazite having a Si/Al ratio of 1.8 to 2.3 by mixing an alumina source, sodium hydroxide, potassium hydroxide, a TMA reagent at a ratio of (TMA)₂O: Al₂O₃ of 0.08 to 0.0001, and a silica source to form a gel, crystallizing the gel by heating at a temperature of from about 25° C. to 150 ° C. for at least one hour, and separating the resulting chabazite product.

The objective of the present disclosure is to provide a new zeolite of the chabazite-type that allows good adsorption of carbon dioxide together with a good selectively over nitrogen and/or methane. Another objective of the disclosure is to provide a process to produce such a chabazite-type zeolite that is cost-effective.

### SUMMARY

It is an object of the disclosure to provide a new zeolite of the chabazite-type and a process for the preparation of such zeolite. Another object is to provide the amorphous precursors of the new zeolite of the chabazite-type and a process for the preparation of such amorphous precursors. A further object of the disclosure is to provide new zeolite of the chabazite-type as a sorbent of carbon dioxide, that can be used in a method of preparing clathrate hydrate substance and that can be used as a catalyst in a chemical process.

According to a first aspect, the disclosure provides a chabazite-type zeolite comprising at least two cages composed of 4- and 8-membered rings connected by one 6-membered double ring, remarkable in that it has a Si/Al molar ratio comprised between 1 and 15 as determined by ²⁹Si magic angle spinning nuclear magnetic resonance, said chabazite-type zeolite comprises caesium and potassium with a Cs/K molar ratio of at most 5.0 as determined by Inductively Coupled Plasma Optical Emission Spectrometry; and said chabazite-type zeolite forms nanoparticles with an average crystal size comprised between 5 nm and 250 nm as determined by the Scherrer equation and with a specific surface area comprised between 50 m² g⁻¹ and 200 m² g⁻¹, as determined by N₂ sorption measurements.

In preferred embodiments, the Si/Al molar ratio is comprised between 1 and 14 as determined by ²⁹Si magic angle spinning nuclear magnetic resonance, preferably between 1 and 10, more preferably between 1 and 8, even more preferably between 1 and 5, most preferably between 1 and 4, and even most preferably between 1 and 3 or between 1 and 2.9 or between 1 and 2.8.

For example, the Si/Al molar ratio as determined by ²⁹Si magic angle spinning nuclear magnetic resonance can be comprised between 1.5 and 2.6; or between 1.5 and 1.9; or between 1.9 and 2.1, or between 2.4 and 2.6. For example, the chabazite-type zeolite has a Si/Al molar ratio as determined by ²⁹Si magic angle spinning nuclear magnetic resonance comprised between 1.10 and 3.00, more preferably comprised between 1.25 and 2.60, more preferably comprised between 1.40 and 2.40, even more preferably comprised between 1.50 and 2.10.

For example, the Si/Al molar ratio as determined by ²⁹Si magic angle spinning nuclear magnetic resonance is at least 1.0 or at least 1.1, preferably at least 1.2 or at least 1.25, more preferably at least 1.4 or at least 1.5; more preferably at least 1.9; even more preferably at least 2.1 and most preferably at least 2.4.

For example, the Si/Al molar ratio as determined by ²⁹Si magic angle spinning nuclear magnetic resonance is at most 10, preferably at most 8, more preferably at most 5; even more preferably at most 4, most preferably at most 3.0 and even most preferably at most 2.9, or at most 2.8 or at most 2.7, or at most 2.6.

Surprisingly, the inventors have found that it was possible to produce, without the need of an organic template, a zeolite of the chabazite-type zeolite that has a low Si/Al molar ratio, is downsized and/or nanosized and has an improved specific surface area. This allows for providing a certain level of cation that can partially block the pore and subsequently, because the cations are slightly mobile, the zeolite can adsorb selectively certain molecules, such as carbon dioxide, over other molecules (such as nitrogen and/or methane). In fact, due to the different factors, such as the size, the electronic interactions and/or the electronic repulsions, in combination with the presence of the cations, the molecules of carbon dioxide can enter into the zeolite framework by displacing the cations, while the molecules of methane are not able to achieve this.

The level of the crystallinity of the chabazite-type zeolite of the present disclosure is very high (up to 100%). The new zeolite also exhibits a high level of durability and/or heat resistance. Indeed, the chabazite-type zeolite of the present disclosure can survive to ion-exchange to be transformed into their acidic form or to vary the counterions on the zeolite, which allows for tuning up the zeolites and varying the selectivity of the zeolites when used as a catalytic system and/or in adsorption-related applications. The zeolite of the present disclosure can also survive to a calcination step that is carried out up to 800° C. The ion-exchanged zeolite can also survive to a calcination step that is carried out up to 450° C.

The zeolite of the disclosure has the further advantage to be fluoride-free, and therefore health-safety for the operators.

For example, the Cs/K molar ratio is at most 4.0 as determined by Inductively Coupled Plasma Optical Emission Spectrometry, preferably at most 3.0; more preferably at most 2.5; even more preferably at most 2.0, and more preferably at most 1.9 and at most 1.8.

For example, the Cs/K molar ratio is at least 0.1 as determined by Inductively Coupled Plasma

Optical Emission Spectrometry; preferably at least 0.2, more preferably at least 0.3; even more preferably at least 0.4 and most preferably at least 0.5.

With preference, one or more of the following embodiments can be used to better define the chabazite-type zeolite of the present disclosure:
The nanoparticle has a specific surface area comprised between 60 m² g⁻¹ and 190 m² g⁻¹ as determined by N₂ adsorption measurements; preferably 75 m² g⁻¹ and 175 m² g⁻¹; more preferably comprised between 100 m² g⁻¹ and 150 m² g⁻¹.
Said nanoparticles have an average pore size diameter comprised between 3.72 Å and 4.20 Å, as determined by Brunauer-Emmet-Teller experiments, preferably of 3.80 Å.
The chabazite-type zeolite comprises a pore volume comprised between 0.10 cm³ g⁻¹ and 0.50 cm³ g⁻¹, as determined by N₂ sorption measurements, preferably between 0.20 cm³ g⁻¹ and 0.40 cm³ g⁻¹, more preferably between 0.25 cm³ g⁻¹ and 0.35 cm³ g⁻¹.
The chabazite-type zeolite comprises a pore volume which is N₂ accessible.
The chabazite-type zeolite has an M¹/Al molar ratio ranging from 0.02 to 0.20 wherein M¹ is selected from Na and/or Li; as determined by Inductively Coupled Plasma Optical Emission Spectrometry; preferably from 0.05 to 0.15; more preferably from 0.075 and 0.12.
The chabazite-type zeolite has a Na/Al molar ratio ranging from 0.02 to 0.20 as determined by Inductively Coupled Plasma Optical Emission Spectrometry; preferably from 0.05 to 0.15; more preferably from 0.075 and 0.12.
The chabazite-type zeolite has an M¹/Cs molar ratio ranging from 0.10 to 0.50 wherein M¹ is selected from Na and/or Li, as determined by Inductively Coupled Plasma Optical Emission Spectrometry, preferably from 0.14 to 0.40; more preferably from 0.17 and 0.30.
The chabazite-type zeolite has a Na/Cs molar ratio ranging from 0.10 to 0.50 wherein M¹ is selected from Na and/or Li, as determined by Inductively Coupled Plasma Optical Emission Spectrometry, preferably from 0.14 to 0.40; more preferably from 0.17 and 0.30.
The chabazite-type zeolite has a Cs/Al molar ratio comprised between 0.15 and 0.45 as determined by Inductively Coupled Plasma Optical Emission Spectrometry, preferably between 0.20 and 0.40, more preferably between 0.21 and 0.39, even more preferably between 0.22 and 0.38.
The chabazite-type zeolite has a content of aluminium that is equal to the sum of the cations used as metallic precursors.
The chabazite-type zeolite has a content of aluminium that is equal to the sum of the amount of sodium, lithium, potassium and/or caesium.
The chabazite-type zeolite has a content of oxygen that is equal to the double of the sum of the amount of silicon and the amount of aluminium.

With preference, one or more of the following embodiments can be used to better define the crystal size of the chabazite-type zeolite of the present disclosure:
The average crystal size of the nanoparticles is comprised between 10 nm and 245 nm as determined by the Scherrer equation, preferably between 15 nm and 235 nm, more preferably between 20 nm and 225 nm, even more preferably between 50 nm and 220 nm, most preferably between 80 nm and 200 nm, even most preferably between 90 nm and 145 nm.
The average crystal size of the nanoparticles is at least 10 nm and at most 250 nm as determined by the Scherrer equation, preferably at most 220 nm more preferably at most 200 nm, even more preferably at most 195 nm or at most 190 nm, even more preferably at most 185 nm, most preferably at most 175 nm, even most preferably at most 165 nm.

In one embodiment, the chabazite-type zeolite forms monodispersed nanoparticles preferably monodispersed nanoparticles comprising single nanocrystals.

In one alternative embodiment, the chabazite-type zeolite forms aggregates, preferably aggregates of nanocrystals.
The aggregates have a size ranging between 400 nm and 2000 nm, as determined by scanning electron microscopy, preferably between 425 nm and 1900 nm, more preferably between 450 nm and 1800 nm, even more preferably between 500 nm and 1700 nm, most preferably between 550 nm and 1600 nm, even most preferably between 600 nm and 1500 nm.
The aggregates have a size of at least 400 nm and/or of at most 2000 nm, as determined by scanning electron microscopy, preferably of at least 450 nm, more preferably of at least 600 nm, even more preferably of at least 650 nm, most preferably of at least 1000 nm, even most preferably of at least 1600 nm, and/or preferably of at most 1800 nm, more preferably of at most 1600 nm, even more preferably of at most 1000 nm, most preferably of at most 650 nm, even most preferably of at most 600 nm.
The chabazite-type zeolite forms aggregated nanocrystals forming spheroidal particles and/or flake-shape particles.

According to a second aspect, the disclosure provides an amorphous precursor of chabazite-type zeolite for the preparation of a chabazite-type zeolite in accordance with the first aspect of the disclosure, said amorphous precursor of chabazite-type zeolite being remarkable in that it has a molar composition comprising
a SiO₂:b Al₂O₃:c M¹₂O:d K₂O:e Cs₂O:f H₂O,

wherein a, b, c, d, e, and f are coefficients; wherein

the coefficient a is ranging from at least 10.0 and at most 20.0;

the coefficient b is ranging from at least 0.3 and at most 2.5;

the coefficient c is ranging from at least 5.0 and at most 11.0;

the coefficient d is ranging from at least 0.7 and at most 1.6;

the coefficient e is ranging from at least 0.05 and at most 0.60; and

the coefficient f is ranging from at least 60 and at most 200

wherein M¹ is selected from Na and/or Li.

According to the disclosure, the molar composition is devoid of an organic structure-directing agent.

Surprisingly, the inventors have found that a precursor as defined in the second aspect of the present disclosure provides for the development of nanosized chabazite-type zeolite according to the first aspect. The amorphous precursors do not contain any organic template. No seeds of a previously formed crystal of chabazite-type zeolite are present. No organic structure-directing agent (OSDA) is present either. The amorphous precursor of chabazite-type zeolite is also fluoride-free.

With preference, one or more of the following embodiments can be used to better define the amorphous precursor of chabazite-type zeolite of the present disclosure:
M¹₂O is or comprises Na₂O.
The amorphous precursor of chabazite-type zeolite forms a suspension with a refractive index ranging between 1.303 and 1.363, said refractive index is determined by refractometry, preferably the refractive index is ranging between 1.313 and 1.353, more preferably between 1.323 and 1.343, even more preferably is 1.333.
The (M¹₂O+Cs₂O)/SiO₂ ratio is at least 0.25 wherein M¹ is selected from Na and/or Li; preferably at least 0.30, more preferably at least 0.35, even more preferably at least 0.40, most preferably at least 0.50, even most preferably at least 0.55.
The (Na₂O+Cs₂O)/SiO₂ ratio is at least 0.25, preferably at least 0.30, more preferably at least 0.35, even more preferably at least 0.40, most preferably at least 0.50, even most preferably at least 0.55.
The (M¹₂O+Cs₂O)/SiO₂ ratio is ranging from 0.25 to 1.25, preferably from 0.30 to 1.20, more preferably from 0.35 to 1.15, even more preferably from 0.40 to 1.10, most preferably from 0.45 to 1.05.
The (Na₂O+Cs₂O)/SiO₂ ratio is ranging from 0.25 to 1.25, preferably from 0.30 to 1.20, more preferably from 0.35 to 1.15, even more preferably from 0.40 to 1.10, most preferably from 0.45 to 1.05.
The (M¹₂O+Cs₂O+K₂O)/SiO₂ ratio is at least 0.55 wherein M¹ is selected from Na and/or Li, preferably is ranging from 0.55 to 1.00; more preferably from 0.58 to 0.95 and even more preferably from 0.60 to 0.90.
The (Na₂O+Cs₂O+K₂O)/SiO₂ ratio is at least 0.55, preferably is ranging from 0.55 to 1.00; more preferably from 0.58 to 0.95 and even more preferably from 0.60 to 0.90.
The ratio M¹₂O/H₂O is superior or equal to 0.025, preferably superior or equal to 0.03, more preferably superior or equal to 0.04, even more preferably superior or equal to 0.05. The ratio M¹₂O/H₂O is the ratio c/f.
The ratio M¹₂O/Al₂O₃ is superior or equal to 4.0, preferably superior or equal to 7.0, more preferably superior or equal to 7.5. The ratio M¹₂O/Al₂O₃ is the ratio c/b.
The ratio Cs₂O/Al₂O₃ is inferior or equal to 0.90, preferably inferior or equal to 0.80, more preferably inferior or equal to 0.75, even more preferably inferior or equal to 0.60. The ratio Cs₂O/Al₂O₃ is the ratio e/b.

Whatever the selection of M¹₂O, but preferably when M¹₂O is Na₂O: that the coefficient a is ranging from at least 10.0 and at most 16.0 (i.e. 10.0≤a≤16.0). For example, the coefficient a is equal to 10 or 16.

For example, the coefficient a is ranging from at least 10.0 and at most 18.0; preferably that the coefficient a is ranging from at least 10.0 and at most 16.0.

In an embodiment, the coefficient b is at least 0.4, preferably at least 0.5, more preferably at least 0.6, even more preferably at least 0.7 and most preferably at least 0.8.

In an embodiment, the coefficient b is at most 2.3, preferably at most 2.2, more preferably at most 2.0, even more preferably at most 1.5 and most preferably at most 1.0.

For example, the coefficient b is ranging between at least 0.7 and most 2.3, preferably between at least 0.8 and at most 2.2, more preferably is equal to 0.7 or 0.8. For example, the coefficient b is ranging between at least 0.5 and most 2.5 (i.e. 0.5≤b≤2.5); preferably at least 0.5 and most 1.5; more preferably at least 0.5 and most 1.0. For example, at least 0.3 and most 1.5 or at least 0.3 and most 1.0.

In an embodiment, the coefficient c is at least 5.5, preferably at least 6.0, more preferably at least 6.5, even more preferably at least 7.0 and most preferably at least 7.5.

In an embodiment, the coefficient c is at most 10.5, preferably at most 10.0, more preferably at most 9.5, even more preferably at most 9.0 and most preferably at most 8.5.

In an embodiment, the coefficient c is ranging between 6.5 and 9.5, preferably between 7.0 and 9.0, more preferably between 7.5 and 8.5, even more preferably is equal to 9.5. For example, the coefficient c is ranging between 5.0 and 10.0; preferably, the coefficient c is ranging between 6.0 and 10.0.

In an embodiment, the coefficient d is at least 0.80, preferably at least 0.90, more preferably at least 1.00, even more preferably at least 1.10, most preferably at least 1.15, and even more preferably at least 1.20 or at least or equal to 1.25.

In an embodiment, the coefficient d is at most 1.50, preferably at most 1.40, more preferably at most 1.35, even more preferably at most 1.30 and most preferably at most or equal to 1.25.

In an embodiment, the coefficient d is ranging between 0.80 and 1.60, preferably between 1.00 and 1.50, more preferably between 1.10 and 1.40, more preferably between 1.15 and 1.35, even more preferably between 1.20 and 1.30, even most preferably is equal to 1.25.

In an embodiment, the coefficient e is at least 0.10, preferably at least 0.15, more preferably at least 0.20, even more preferably at least 0.25 and most preferably at least 0.30.

In an embodiment, the coefficient e is at most 0.55, preferably at most 0.50, more preferably at most 0.45, even more preferably at most 0.40 and most preferably at most 0.35.

For example, the coefficient e is ranging between 0.15 and 0.50, preferably between 0.20 and 0.45, more preferably between 0.25 and 0.40, even more preferably between 0.30 and 0.35, preferably is equal to 0.15 or at least 0.15 and at most 0.45.

In an embodiment, the coefficient f is at least 70, preferably at least 80, more preferably at least 90, even more preferably at least 100, most preferably at least 110 and even most preferably at least 120 or at least 130.

In an embodiment, the coefficient f is at most 190, preferably at most 180, more preferably at most 170, even more preferably at most 160, most preferably at most 150 and even most preferably at most 140.

For example, the coefficient f is ranging between 90 and 190, preferably between 100 and 180, more preferably between 110 and 170, even more preferably between 120 and 160, most preferably between 130 and 140, even most preferably is equal to 140. For example, the coefficient f is at least 80 and at most 190; preferably at least 90 and at most 160.

In an embodiment, the amorphous precursor of chabazite-type zeolite for the preparation of a chabazite-type zeolite according to the first aspect is remarkable in that said amorphous precursor of chabazite-type zeolite has a molar composition comprising

a SiO₂:b Al₂O₃:c M¹₂O:d K₂O:e Cs₂O:f H₂O,

wherein a, b, c, d, e, and f are coefficients, wherein

the coefficient a is ranging from at least 10.0 and at most 16.0;

the coefficient b is ranging from at least 0.5 and at most 2.5;

the coefficient c is ranging from at least 6.0 and at most 10.0;

the coefficient d is ranging from at least 0.8 and at most 1.6;

the coefficient e is ranging from at least 0.05 and at most 0.60; and

the coefficient f is ranging from at least 90 and at most 190;

wherein M¹₂O is selected from Na₂O and/or Li₂O

The Si/Al molar ratio of the amorphous precursor of chabazite-type zeolite is comprised between 2 and 16.

For example, when the coefficient a is equal to 10, then
0.6≤b≤0.8;
6.0≤c≤8.0
1.25≤d≤1.35;
0.20≤e≤0.30; and
120≤f≤190.

For example, when the coefficient a is equal to 10, then
b=0.8;
c=8.0;
d=1.35;
e=0.30; and
f=120 or f=190.

For example, when the coefficient a is equal to 10, then
b=0.8;
9.0≤c≤9.5
d=0.85;
e=0.35; and
110≤f≤130.

For example, when the coefficient a is equal to 16, then
0.4≤b≤0.8;
6.0≤c≤9.5;
0.85≤d≤1.35;
0.15e≤0.35; and
120≤f≤150.

For example, when the coefficient a is equal to 16, then
0.4≤b≤0.6;
c=6.0;
d=1.35;
0.15≤e≤0.25; and
130≤f≤150.

According to a third aspect, the disclosure provides for a method for the preparation of an aqueous amorphous precursor of chabazite-type zeolite as defined in accordance with the second aspect of the disclosure, comprising the following steps,

a) providing an aluminate precursors aqueous suspension;

b) providing a silicate precursors aqueous suspension;

c) adding at least three metallic precursors in the said aluminate precursors aqueous suspension to form a first aqueous suspension and/or in the said silicate precursors aqueous suspension to form a second aqueous suspension;

d) forming an amorphous precursor of chabazite-type zeolite by adding dropwise the aluminate precursors aqueous suspension into said second aqueous suspension; or by adding dropwise the silicate precursors aqueous suspension into said first aqueous suspension; or by adding dropwise the said first or the said second aqueous suspension into said second or said first aqueous suspension;

wherein the at least three metallic precursors comprises caesium hydroxide, potassium hydroxide and at least one selected from sodium hydroxide and/or lithium hydroxide. With preference, the at least three metallic precursors comprise caesium hydroxide, potassium hydroxide and sodium hydroxide.

Surprisingly, the inventors have found that the preparation of amorphous precursors of chabazite-type zeolite without the use of a template (no organic structure-directing agent (OSDA) is present) can lead to a mixture that is capable of being transformed into crystalline chabazite zeolite. Additionally, the amorphous precursors prepared by this method have the interesting advantageous to form crystals that are downsized and/or nanosized. The resulting amorphous precursor of chabazite-type zeolite forms a clear suspension.

For example, the method for the preparation of an amorphous precursor of a chabazite-type zeolite as defined in the second aspect comprises the following steps:
a) providing an aluminate precursors aqueous suspension;
b) providing a silicate precursors aqueous suspension;
c) adding at least three metallic precursors in the said aluminate precursors aqueous suspension to form a first aqueous suspension, wherein the at least three metallic precursors comprises caesium hydroxide, potassium hydroxide and at least one selected from sodium hydroxide and/or lithium hydroxide;
d) forming an amorphous precursor of zeolite by adding dropwise the silicate precursors aqueous suspension into said first aqueous.

With preference, the at least three metallic precursors comprise caesium hydroxide, potassium hydroxide and sodium hydroxide.

With preference, said the first aqueous suspension comprises water and 5.0 wt. % to 15.0 wt. % based on the total weight of the first aqueous suspension of one or more aluminate precursors; and from 15 wt. % to 80 wt. % of the at least three metallic precursors.

For example, the method for the preparation of an amorphous precursor of a chabazite-type zeolite as defined in the second aspect comprises the following steps:
a) providing an aluminate precursors aqueous suspension;
b) providing a silicate precursors aqueous suspension;
c) adding at least three metallic precursors in the said silicate precursors aqueous suspension to form a second aqueous suspension, wherein the at least three metallic precursors comprise caesium hydroxide, potassium hydroxide and at least one selected from sodium hydroxide and/or lithium hydroxide;
d) forming an amorphous precursor of zeolite by adding dropwise the aluminate precursors aqueous suspension into said second aqueous suspension.

With preference, the at least three metallic precursors comprise caesium hydroxide, potassium hydroxide and sodium hydroxide.

With preference, said second aqueous suspension comprises water and from 10 wt. % to 35 wt. % based on the total weight of the second aqueous suspension of one or more silicate precursors; and from 10 wt. % to 60 wt. % of the at least three metallic precursors.

For example, the method for the preparation of an amorphous precursor of a chabazite-type zeolite as defined in the second aspect comprises the following steps,
a) providing an aluminate precursors aqueous suspension;
b) providing a silicate precursors aqueous suspension;
c) adding at least three metallic precursors in the said aluminate precursors aqueous suspension to form a first aqueous suspension and in the said silicate precursors aqueous suspension to form a second aqueous suspension, wherein the at least three metallic precursors comprise caesium hydroxide, potassium hydroxide and at least one selected from sodium hydroxide and/or lithium hydroxide;
d) forming an amorphous precursor of zeolite by adding dropwise the said first aqueous suspension into said second aqueous suspension or by adding dropwise the said second aqueous suspension into said first aqueous suspension.

With preference, the at least three metallic precursors comprise caesium hydroxide, potassium hydroxide and sodium hydroxide.

With preference, the first aqueous suspension comprises water and from 5.0 wt. % to 15.0 wt. % based on the total weight of the first aqueous suspension of one or more aluminate precursors; and from 15 wt. % to 80 wt. % of the at least three metallic precursors; and/or the second aqueous suspension comprises water and from 10 wt. % to 35 wt. % based on the total weight of the second aqueous suspension of one or more silicate precursors; and from 10 wt. % to 60 wt. % of the at least three metallic precursors.

With preference, the step (d) of adding dropwise said aluminate precursors aqueous suspension into said second aqueous suspension to form an amorphous precursor of chabazite-type zeolite; or of adding dropwise said silicate precursors aqueous suspension into said first aqueous suspension to form an amorphous precursor of chabazite-type zeolite; is performed while the second aqueous suspension or the first aqueous suspension respectively is kept on ice.

With preference, the step (d) of adding dropwise the said first or the said second aqueous suspension into said second or said first aqueous suspension respectively while kept on ice.

### The Aluminate Precursors Aqueous Suspension

With preference, one or more of the following embodiments can be used to better define the aluminate precursors aqueous suspension:
The one or more aluminate precursors are selected among Na₂Al₂O₄, Al₂(SO₄)₃, hydrated alumina, aluminium powder, AlCl₃, Al(OH)₃, kaolin clays and a mixture thereof, preferably Na₂Al₂O₄ (note: another notation for Na₂Al₂O₄ is NaAlO₂).
Na₂Al₂O₄, when selected, comprised between 48 wt. % and 63 wt. % of Al₂O₃ and between 37 wt. % and 52 wt. % of Na₂O, preferably 53 wt. % of Al₂O₃ and 47 wt. % of Na₂O.
The one or more aluminate precursors are present in an amount comprised between 3 wt. % and 25 wt. % of the total weight of the aluminate precursors aqueous suspension, preferably between 5 wt. % and 20 wt. %, more preferably between 6 wt. % and 10 wt. %, even more preferably between 6.5 wt. % and 9 wt. %.
The aluminate precursors aqueous suspension comprises water, preferably distilled water, more preferably double distilled water.

### The Silicate Precursors Aqueous Suspension

With preference, one or more of the following embodiments can be used to better define the silicate precursors aqueous suspension:
The one or more silicate precursors of the silicate precursors aqueous suspension are selected among colloidal silica, silica oxyhydroxide species, silica hydrogel, silicic acid, fumed silica, tetraalkyl orthosilicates, silica hydroxides, precipitated silica, clays and a mixture thereof, preferably colloidal silica.
Colloidal silica, when selected, comprises amorphous, nonporous, and spherical silica particles in an aqueous suspension in an amount comprised between 20 wt. % and 50 wt. % of the total weight of said aqueous suspension, preferably between 25 wt. % and 45 wt. %, more preferably of 30 wt. % or 40 wt. %.
The one or more silicate precursors of the silicate precursors aqueous suspension are present in an amount comprised between 10 wt. % and 50 wt. % of the total weight of the silicate precursors aqueous suspension, preferably between 15 wt. % and 45 wt. %, more preferably between 20 wt. % and 35 wt. %.
The silicate precursors aqueous suspension comprises water, preferably distilled water, more preferably double distilled water.

### The Metallic Precursors

In a preferred embodiment, said three metallic precursors are a mixture of KOH, CsOH and at least one selected from NaOH and/or LiOH; preferably, said at least three metallic precursors are a mixture of KOH, CsOH and NaOH.

### The First Aqueous Suspension

In a preferred embodiment, the content of the at least two metallic precursors in the first aqueous suspension is ranging from 1 wt. % to 97.5 wt. % of the total weight of the first aqueous suspension, preferably from 20 wt. % to 80 wt. %, more preferably from 25 wt. % and 55 wt. %, and most preferably from 30 to 50 wt. %.

In a more preferred embodiment, the first aqueous suspension comprises water and:
from 5.0 to 15.0 wt. % based on the total weight of the first aqueous suspension of one or more aluminate precursors; preferably from 5.5 to 12.5 wt. %; more preferably from 6.0 to 11.5 wt. %; even more preferably from 6.5 to 10.0 wt. %. and from 15 wt. % to 80 wt. % of the at least three metallic precursors, comprising
from 1 to 30 wt. % based on the total weight of the first aqueous suspension of one or more caesium precursors; and
from 14 to 50 wt. % based on the total weight of the first aqueous suspension of one or more additional precursors comprising:
   one or more potassium precursors; and
   one or more selected from one or more sodium precursors, one or more lithium precursors, and any mixture thereof; preferably one or more sodium precursors.

With preference, the first aqueous suspension comprises at most 30 wt. % based on the total weight of the first aqueous suspension of one or more caesium precursors; preferably at most 25 wt. %; more preferably at most 20 wt. %; even more preferably at most 15 wt. %; and most preferably at most 10 wt. %.

With preference, the first aqueous suspension comprises at least 1 wt. % based on the total weight of the first aqueous suspension of one or more caesium precursors; preferably at least 1.5 wt. %; more preferably at least 2 wt. %; even more preferably at least 2.5 wt. %; and most preferably at least 3 wt. %.

With preference, the first aqueous suspension comprises at most 50 wt. % based on the total weight of the first aqueous suspension of one or more additional precursors comprising one or more potassium precursors; one or more selected from sodium precursors, and/or lithium precursors; preferably at most 48 wt. %; more preferably at most 45 wt. %; even more preferably at most 40 wt. %; and most preferably at most 38 wt. %.

With preference, the first aqueous suspension comprises at least 14 wt. % based on the total weight of the first aqueous suspension of one or more additional precursors comprising one or more potassium precursors; one or more selected from sodium precursors, and/or lithium precursors; preferably at least 15 wt. %; more preferably at least 20 wt. %; even more preferably at least 22 wt. %; and most preferably at least 25 wt. %.

With preference, the first aqueous suspension comprises from 14 to 50 wt. % based on the total weight of the first aqueous suspension of one or more additional precursors comprising:
from 2 wt. % to 15 wt. % based on the total weight of the first aqueous suspension of one or more potassium precursors; and
from 12 wt. % to 35 wt. % based on the total weight of the first aqueous suspension of one or more selected from one or more sodium precursors, one or more lithium precursors, and any mixture thereof; preferably one or more sodium precursors.

More preferably, the first aqueous suspension comprises from 25 to 45 wt. % based on the total weight of the first aqueous suspension of one or more additional precursors comprising:
from 4 wt. % to 12 wt. % based on the total weight of the first aqueous suspension of one or more potassium precursors; and
from 21 wt. % to 33 wt. % based on the total weight of the first aqueous suspension of one or more selected from one or more sodium precursors, one or more lithium precursors, and any mixture thereof; preferably one or more sodium precursors.

### The Second Aqueous Suspension

In another embodiment, the content of the at least two metallic precursors in the second aqueous suspension is ranging from 1 wt. % to 97.5 wt. % of the total weight of the second aqueous suspension, preferably from 20 wt. % to 80 wt. %, more preferably from 25 wt. % and 55 wt. %, and most preferably from 30 to 50 wt. %.

In a more preferred embodiment, the second aqueous suspension comprises water and:
from 10 to 35 wt. % based on the total weight of the second aqueous suspension of one or more silicate precursors; preferably from 15 to 30 wt. %; more preferably from 18 to 27 wt. %; and
from 10 wt. % to 60 wt. % of the at least three metallic precursors, comprising:
   from 1 to 25 wt. % based on the total weight of the second aqueous suspension of one or more caesium precursors; and
   from 9 to 35 wt. % based on the total weight of the second aqueous suspension of one or more additional precursors comprising:
      one or more potassium precursors; and
      one or more selected from one or more sodium precursors, one or more lithium precursors, and any mixture thereof; preferably one or more sodium precursors.

With preference, the second aqueous suspension comprises at most 25 wt. % based on the total weight of the second aqueous suspension of one or more caesium precursors; preferably at most 20 wt. %; more preferably at most 15 wt. %; even more preferably at most 10 wt. %; and most preferably at most 5 wt. %.

With preference, the second aqueous suspension comprises at least 1 wt. % based on the total weight of the second aqueous suspension of one or more caesium precursors; preferably at least 1.5 wt. %; more preferably at least 2 wt. %; even more preferably at least 2.5 wt. %; and most preferably at least 3 wt. %.

With preference, the second aqueous suspension comprises at most 35 wt. % based on the total weight of the second aqueous suspension of one or more additional precursors comprising one or more potassium precursors and one or more selected from sodium precursors, and/or lithium precursors; preferably at most 30 wt. %; more preferably at most 25 wt. %; even more preferably at most 20 wt. %; and most preferably at most 15 wt. %.

With preference, the second aqueous suspension comprises at least 9 wt. % based on the total weight of the second aqueous suspension of one or more additional precursors comprising one or more potassium precursors and one or more selected from sodium precursors, and/or lithium precursors; preferably at least 10 wt. %; more preferably at least 11 wt. %; even more preferably at least 12 wt. %; and most preferably at least 13 wt. %.

With preference, the second aqueous suspension comprises from 9 to 35 wt. % based on the total weight of the second aqueous suspension of one or more additional precursors comprising:
from 1 wt. % to 13 wt. % based on the total weight of the second aqueous suspension of one or more potassium precursors; and
from 8 wt. % to 22 wt. % based on the total weight of the second aqueous suspension of one or more selected from one or more sodium precursors, one or more lithium precursors, and any mixture thereof; preferably one or more sodium precursors.

More preferably, the second aqueous suspension comprises from 12 to 32 wt. % based on the total weight of the second aqueous suspension of one or more additional precursors comprising:
from 2 wt. % to 12 wt. % based on the total weight of the second aqueous suspension of one or more potassium precursors; and
from 10 wt. % to 20 wt. % based on the total weight of the second aqueous suspension of one or more selected from one or more sodium precursors, one or more lithium precursors, and any mixture thereof; preferably one or more sodium precursors.

### The Formation of the Amorphous Precursor

In a preferred embodiment, the weight ratio of the aqueous suspension containing one or more aluminate precursors over the aqueous suspension containing one or more silicate precursors is comprised between 0.25 and 1.5, preferably between 0.30 and 1.45, more preferably between 0.35 and 1.40, even more preferably between 0.50 and 1.25; wherein the aqueous suspension containing one or more aluminate precursors is the aluminate precursors aqueous suspension or the first aqueous suspension; and the aqueous suspension containing one or more silicate precursors is the second aqueous suspension or the silicate precursors aqueous suspension, respectively.

With preference, the following one or more embodiments can be used to better define the step d):
The dropwise addition of the aqueous suspension containing one or more aluminate precursors over the aqueous suspension containing one or more silicate precursors is performed in a temperature comprised between −5° C. and 25° C., preferably in a temperature comprised between 20° C. and 25° C.
The dropwise addition of the aqueous suspension containing one or more aluminate precursors over the aqueous suspension containing one or more silicate precursors is performed under stirring, preferably under stirring of at least 500 rpm, more preferably of at least 750 rpm.
The dropwise addition of the aqueous suspension containing one or more silicate precursors over the aqueous suspension containing one or more aluminate precursors is performed in a temperature comprised between 15° C. and 25° C.
The dropwise addition of the aqueous suspension containing one or more silicate precursors over the aqueous suspension containing one or more aluminate precursors is performed under stirring, preferably under stirring of at least 500 rpm, more preferably of at least 750 rpm.

According to a fourth aspect, the disclosure provides for a method for the preparation of chabazite-type zeolite as defined in accordance with the first aspect of the disclosure, comprising the method for the preparation of an aqueous amorphous precursor of chabazite-type zeolite according to the third aspect of the disclosure and further comprising the following steps:
e) mixing said amorphous precursor under stirring and/or orbital shaking;
f) optionally, adding an additional silicate precursors aqueous suspension and mixing said amorphous precursor under stirring and/or orbital shaking;
g) heating said amorphous precursor at a temperature comprised between 90° C. and 160° C., such as to form one or more crystals of chabazite-type zeolite;
h) cooling down said one or more crystals of chabazite-type zeolite at a temperature comprised between 20° C. and 25° C.,
i) dispersing said one or more crystals of chabazite-type zeolite in water,
j) optionally, recovering said one or more crystals of chabazite-type zeolite.

Surprisingly, the inventors have found a method to prepare downsized and/or nanosized chabazite-type zeolite and wherein the downsized and/or nanosized chabazite-type zeolites exhibit an important pore volume. The method of the present disclosure affords a very high level of crystallinity of the chabazite-type zeolite (up to 100%).

With preference, one or more of the following embodiments can be used to better define the method for the preparation of chabazite-type zeolite of the present disclosure:
Step (e) is performed at room temperature, preferably at a temperature comprised between 20° C. and 25° C.
Step (e) is carried out for a period comprised between 15 hours and 15 days, preferably for at least 20 hours and/or at most 15 days.
Step (e) is carried out under mechanical stirring at 700 rpm.
Step (e) is carried out in a sealed environment, preferably at a pressure of 0.1 MPa.
Said step (e) comprises the step of ageing, namely of mixing without stirring.
Step (f), when present, is carried out after a period comprised between 4 and 7 days after the start of step (e).
The amount of the third aqueous suspension added in step (f) when said step (f) is carried out corresponds to an amount comprised between 50 wt. % and 70 wt. % of the amount of the second aqueous suspension, preferably between 55 wt. % and 65 wt. %, more preferably is 60 wt. %.
The one or more silicate precursors of the additional silicate precursors aqueous suspension are different or the same as the one or more silicate precursors of the silicate precursors aqueous suspension.
The one or more silicate precursors of the additional silicate precursors aqueous suspension are selected among colloidal silica, silica oxyhydroxide species, silica hydrogel, silicic acid, fumed silica, tetraalkyl orthosilicates, silica hydroxides, precipitated silica, clays and a mixture thereof, preferably the silicate precursor of the additional silicate precursors aqueous suspension is colloidal silica.
The one or more silica precursors of the additional silicate precursors aqueous suspension are present in an amount comprised between 20 wt. % and 70 wt. % of the total weight of the additional silicate precursors aqueous suspension, preferably between 25 wt. % and 60 wt. %, more preferably between 28 wt. % and 50 wt. %, even more preferably is 30 wt. % or 40 wt. %.
The additional silicate precursors aqueous suspension comprises water, preferably distilled water, more preferably double distilled water.
The mixing step in step (f) is similar to the mixing step (e), except that said mixing step in step (f) is carried out for a period comprised between 0.5 hours and 2 hours, preferably comprised between 1 hour and 1.5 hours.
Step (g) is performed at a temperature comprised between 100° C. and 150° C., preferably between 110° C. and 140° C., more preferably between 120° C. and 130° C.
Step (g) is carried out fora period comprised between 0.5 hour and 15 hours, preferably between 1 hour and 13 hours, more preferably between 2 hours and 12 hours, even more preferably between 7 hours and 11 hours, most preferably between 8 hours and 10 hours.
Step (g) is carried out in a sealed environment.
Step (g) is carried out under autogenous pressure conditions.
Step (g) is performed in the absence of seed crystals.
The water in step (i) is distilled water, preferably double distilled water.
Step (j), when present, comprises the sub-steps of adding water and separating the one or more crystals of chabazite-type zeolite,
Step (j), when present, optionally comprises the sub-step of drying after the sub-step of separating the one or more crystals of chabazite-type zeolite.
The sub-step of adding water is repeated until the pH of the decanting water reaches at least 7.5, preferably until the pH is equal to 8.
The sub-step of separating the one or more crystals of chabazite zeolite is performed by filtration and/or by centrifugation.
The optional sub-step of drying is performed at a temperature of at least 50° C., preferably at 80° C.
A sub-step of freeze-drying is carried out after the sub-step of separating the one or more crystals of chabazite-type zeolite and/or after the optional sub-step of drying.
The sub-step of freeze-drying, when carried out, is carried out at a temperature comprised between −100° C. and −70° C., preferably between −92° C. and −76° C.
Said method, when step (j) is present, further comprises a step (k) of performing an ion-exchange. With preference, the ion-exchange of step (k) is carried out in presence of one salt, the cation of said salt being selected from the alkali metals, the alkaline earth metal, or ammonium; and the anion of said salt is selected from halogens or nitrate, preferably from chloride or nitrate.

According to a fifth aspect, the disclosure provides for a use of the chabazite zeolite as defined in accordance with the first aspect of the disclosure as a sorbent for carbon dioxide; with preference in a process for separation of carbon dioxide from methane or in a process for separation of carbon dioxide from an inert gas such as N₂, He and/or Ar.

Therefore, the disclosure provides a method comprising sorbing polar molecules (H₂O, CO₂) over less polar ones (N₂, CH₄), and thus separating H₂O- and/or CO₂-containing gas mixture, sorbing lower alkanes thus separating alkanes from alkenes (C₂-C₄), or separating nitrogen from a nitrogen-hydrogen gas mixture, by contacting the respective feedstock with the chabazite-type zeolite composition of the disclosure. A method for those separations could be managed as thin films, hollow fibers or membranes assembled from only or a part of the chabazite-type zeolite composition of the disclosure.

According to a sixth aspect, the disclosure provides for a use of the chabazite-type zeolite as defined in accordance with the first aspect of the disclosure in a method of preparing clathrate hydrate substance or clathrate gas substance, wherein said clathrate hydrate or clathrate gas entraps preferentially methane.

According to a seventh aspect, the disclosure provides for a use of the chabazite zeolite as defined in accordance with the first aspect of the disclosure as a catalyst in a chemical process.

### DESCRIPTION OF THE FIGURES

FIG. 1 shows the X-ray diffraction (XRD) of samples 1, 10 and 12.

FIGS. 2A to 2I respectively show the Scanning Electron Microscope (SEM) images of samples 1 to 9.

FIG. 3 shows the N₂ adsorption-desorption isotherm of samples 1, 4, 9, 10, 11 and 12.

FIG. 4 shows the CO₂ adsorption isotherm of samples 1, 9, 10, 11 and 12 recorded at 0° C.

FIG. 5 shows the Rietveld refinement of sample 10.

FIGS. 6A and 6B show the Transmission Electron Microscope (TEM) images of sample 10 at a magnification of 200 nm.

FIG. 6C and 6D respectively show the Transmission Electron Microscope (TEM) images of sample 12 at a magnification of 100 nm and 20 nm.

FIGS. 6E and 6F show the Transmission Electron Microscope (TEM) images of sample 13 at a magnification of 20 nm.

FIG. 7 shows the thermogravimetric analysis of nanosized chabazite zeolite of sample 10 subject to 10 subsequent sorption cycles of CO₂.

FIG. 8 shows the CO₂ capacity of the zeolite of sample 10 in 10 sorption cycles of CO₂.

FIG. 9 shows the XRD patterns of the zeolite of sample 10 before and after 10 sorption cycles of CO₂.

FIG. 10 shows the in situ Fourier Transform Infra-Red (FTIR) spectrum recorded for sample 10 under delivery of a small dose of CO₂ (3.10⁻⁴ mmol to 1.10⁻¹ mmol).

FIG. 11 shows the in situ Fourier Transform Infra-Red (FTIR) spectrum recorded for sample 10 under delivery of a small dose of CH₄ at a partial pressure of 0.1 mbar, 20 mbar, 28 mbar and 33 mbar at room temperature.

FIG. 12 shows the LeBail refinement of ion-exchanged zeolite of sample 10 (proton form).

FIG. 13 shows the in situ XRD patterns of sample 10 recorded under delivery of 1 bar of CO₂.

FIG. 14 shows the evolution of the intensity of the peak at 12.8° 2θ of sample 10 under controlled adsorption of CO₂.

FIG. 15 shows the change of the cell volume of sample 10 under controlled adsorption of CO₂.

FIG. 16 shows the unit cell parameter under adsorption and desorption of CO₂ of sample 10.

FIG. 17 shows the c-potential curve of sample 13.

FIG. 18 shows the normalised mass adsorption of CO₂ and CH₄ as pure gas followed by TGA experiments for sample 10.

FIG. 19 shows the XRD patterns of samples 16-18.

FIG. 20 shows the SEM image of a CHA zeolite (sample 16).

FIG. 21 shows the SEM image of an RHO zeolite (sample 17).

FIG. 22 shows the SEM image of an FAU zeolite with EMT as the secondary phase (sample 18).

### DETAILED DESCRIPTION

For the disclosure, the following definitions are given:

The terms “nanosized” and “nanozeolites” refers to crystals of zeolite having a size lower than 200 nm.

Zeolite codes (e.g., CHA . . . ) are defined according to the “Atlas of Zeolite Framework Types”, 6^{th} revised edition, 2007, Elsevier, to which the present application also refers.

The term “alkali metal” refers to an element classified as an element from group 1 of the periodic table of elements, excluding hydrogen. According to this definition, the alkali metals are Li, Na, K, Rb, Cs, and Fr.

The term “alkaline earth metal” refers to an element classified as an element from group 2 of the periodic table of elements. According to this definition, the alkaline earth metals are Be, Mg, Ca, Sr, Ba, and Ra.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of endpoints also includes the recited endpoint values themselves (e.g. from 1.0 to 5.0 includes both 1.0 and 5.0). Any numerical range recited herein is intended to include all sub-ranges subsumed therein.

The particular features, structures, characteristics or embodiments may be combined in any suitable manner, as would be apparent to a person skilled in the art from this disclosure, in one or more embodiments.

### Method for Preparing the Precursor of the Chabazite-Type

The disclosure provides a method for the preparation of an aqueous amorphous precursor of chabazite-type zeolite, comprising the following steps:

a) providing an aluminate precursors aqueous suspension;

b) providing a silicate precursors aqueous suspension;

c) adding at least three metallic precursors in the said aluminate precursors aqueous suspension to form a first aqueous suspension and/or in the said silicate precursors aqueous suspension to form a second aqueous suspension;

d) forming an amorphous precursor of chabazite-type zeolite by adding dropwise said aluminate precursors aqueous suspension into said second aqueous suspension or by adding dropwise the silicate precursors aqueous suspension into said first aqueous suspension; or by adding dropwise that said first or the said second aqueous suspension into said second or said first aqueous suspension respectively;

wherein the at least three metallic precursors comprises caesium hydroxide, potassium hydroxide and at least one selected from sodium hydroxide and/or lithium hydroxide. With preference, the at least three metallic precursors comprise caesium hydroxide, potassium hydroxide and sodium hydroxide.

In a preferred embodiment, said aluminate precursors aqueous suspension and said silicate precursors aqueous suspension are organic structure-directing agent-free.

The one or more aluminate precursors in the aluminate precursors aqueous suspension provided in step (a) are preferably selected among Na₂l₂O₄, Al₂(SO₄)₃, hydrated alumina, aluminium powder, AlCl₃, Al(OH)₃, kaolin clays and a mixture thereof, preferably Na₂Al₂O₄ (note: another notation for Na₂Al₂O₄ is NaAlO₂). Na₂Al₂O₄, when selected, comprised between 48 wt. % and 63 wt. % of Al₂O₃ and between 37 wt. % and 52 wt. % of Na₂O, preferably 53 wt. % of Al₂O₃ and between 47 wt. % of Na₂O.

The one or more aluminate precursors in the aluminate precursors aqueous suspension provided in step (a) are preferably present in an amount comprised between 3 wt. % and 25 wt. % of the total weight of the aluminate precursors aqueous suspension, more preferably between 5 wt. % and 20 wt. %, even more preferably between 6 wt. % and 10 wt. %. The aluminate precursors aqueous suspension comprises water, preferably distilled water, more preferably double distilled water.

The one or more silicate precursors in the silicate precursors aqueous suspension provided in step (b) are selected among colloidal silica, silica oxyhydroxide species, silica hydrogel, silicic acid, fumed silica, tetraalkyl orthosilicates, silica hydroxides, precipitated silica, clays and a mixture thereof, preferably colloidal silica. Colloidal silica, when selected, comprises amorphous, nonporous, and spherical silica particles in an aqueous suspension in an amount comprised between 20 wt. % and 50 wt. % of the total weight of said aqueous suspension, preferably between 25 wt. % and 45 wt. %, more preferably of 30 wt. % (e.g. Ludox®HS30) or 40 wt. % (e.g. Ludox®HS40).

The one or more silicate precursors in the silicate precursors aqueous suspension provided in step (b) are preferably present in an amount comprised between 10 wt. % and 50 wt. % of the total weight of the silicate precursors aqueous suspension, more preferably between 15 wt. % and 45 wt. %, even more preferably between 20 wt. % and 40 wt. %, even more preferably is 15 wt. % or 35 wt. %. The silicate precursors aqueous suspension comprises water, preferably distilled water, more preferably double distilled water.

Said step (c) comprises the step of adding in both of said aluminate precursors and silicate precursors aqueous suspensions at least three metallic precursors.

In a preferred embodiment, said at least three metallic precursors are a combination of NaOH, KOH, and CsOH.

In a preferred embodiment, the content of the at least two metallic precursors in the first aqueous suspension is ranging from 1 wt. % to 97.5 wt. % of the total weight of the first aqueous suspension, preferably from 20 wt. % to 80 wt. %, more preferably from 25 wt. % and 55 wt. %, and most preferably from 30 to 50 wt. %.

In a more preferred embodiment, the first aqueous suspension comprises water and:
from 5.0 to 15.0 wt. % based on the total weight of the first aqueous suspension of one or more aluminate precursors; preferably from 5.5 to 12.5 wt. %; more preferably from 6.0 to 11.5 wt. %; even more preferably from 6.5 to 10.0 wt. %. and from 15 wt. % to 80 wt. % of the at least three metallic precursors, comprising
from 1 to 30 wt. % based on the total weight of the first aqueous suspension of one or more caesium precursors; and
from 14 to 50 wt. % based on the total weight of the first aqueous suspension of one or more additional precursors comprising:
   one or more potassium precursors; and
   one or more selected from one or more sodium precursors, one or more lithium precursors, and any mixture thereof; preferably one or more sodium precursors.

The amorphous precursor obtained with such composition affords upon crystallization a chabazite-type zeolite that has a CO₂ uptake of at least 3.50 mmol/g of zeolite material

With preference, the first aqueous suspension comprises at most 30 wt. % based on the total weight of the first aqueous suspension of one or more caesium precursors; preferably at most 25 wt. %; more preferably at most 20 wt. %; even more preferably at most 15 wt. %; and most preferably at most 10 wt. %.

With preference, the first aqueous suspension comprises at least 1 wt. % based on the total weight of the first aqueous suspension of one or more caesium precursors; preferably at least 1.5 wt. %; more preferably at least 2 wt. %; even more preferably at least 2.5 wt. %; and most preferably at least 3 wt. %.

With preference, the first aqueous suspension comprises at most 50 wt. % based on the total weight of the first aqueous suspension of one or more additional precursors comprising one or more potassium precursors; one or more selected from sodium precursors, and/or lithium precursors; preferably at most 48 wt. %; more preferably at most 45 wt. %; even more preferably at most 40 wt. %; and most preferably at most 38 wt. %.

With preference, the first aqueous suspension comprises at least 14 wt. % based on the total weight of the first aqueous suspension of one or more additional precursors comprising one or more potassium precursors; one or more selected from sodium precursors, and/or lithium precursors; preferably at least 15 wt. %; more preferably at least 20 wt. %; even more preferably at least 22 wt. %; and most preferably at least 25 wt. %.

With preference, the first aqueous suspension comprises from 14 to 50 wt. % based on the total weight of the first aqueous suspension of one or more additional precursors comprising:
from 2 wt. % to 15 wt. % based on the total weight of the first aqueous suspension of one or more potassium precursors; and
from 12 wt. % to 35 wt. % based on the total weight of the first aqueous suspension of one or more selected from one or more sodium precursors, one or more lithium precursors, and any mixture thereof; preferably one or more sodium precursors.

More preferably, the first aqueous suspension comprises from 25 to 45 wt. % based on the total weight of the first aqueous suspension of one or more additional precursors comprising:
from 4 wt. % to 12 wt. % based on the total weight of the first aqueous suspension of one or more potassium precursors; and
from 21 wt. % to 33 wt. % based on the total weight of the first aqueous suspension of one or more selected from one or more sodium precursors, one or more lithium precursors, and any mixture thereof; preferably one or more sodium precursors.

In one instance, the first aqueous suspension comprises water and:
7.66 wt. % based on the total weight of the first aqueous suspension of one or more aluminate precursors;
4.90 wt. % based on the total weight of the first aqueous suspension of one or more caesium precursors;
5.24 wt. % based on the total weight of the first aqueous suspension of one or more potassium precursors; and
31.77 wt. % based on the total weight of the first aqueous suspension of one or more selected from one or more sodium precursors, one or more lithium precursors, and any mixture thereof; preferably one or more sodium precursors.

In a second instance, the first aqueous suspension comprises water and:
7.06 wt. % based on the total weight of the first aqueous suspension of one or more aluminate precursors;
4.59 wt. % based on the total weight of the first aqueous suspension of one or more caesium precursors;
10.90 wt. % based on the total weight of the first aqueous suspension of one or more potassium precursors; and
25.95 wt. % based on the total weight of the first aqueous suspension of one or more selected from one or more sodium precursors, one or more lithium precursors, and any mixture thereof; preferably one or more sodium precursors.

In another embodiment, the content of the at least two metallic precursors in the second aqueous suspension is ranging from 1 wt. % to 97.5 wt. % of the total weight of the second aqueous suspension, preferably from 20 wt. % to 80 wt. %, more preferably from 25 wt. % and 55 wt. %, and most preferably from 30 to 50 wt. %.

In a more preferred embodiment, the second aqueous suspension comprises water and:
from 10 to 35 wt. % based on the total weight of the second aqueous suspension of one or more silicate precursors; preferably from 15 to 30 wt. %; more preferably from 18 to 27 wt. %; and
from 10 wt. % to 60 wt. % of the at least three metallic precursors, comprising:
   from 1 to 25 wt. % based on the total weight of the second aqueous suspension of one or more caesium precursors; and
   from 9 to 35 wt. % based on the total weight of the second aqueous suspension of one or more additional precursors comprising:
      one or more potassium precursors; and
      one or more selected from one or more sodium precursors, one or more lithium precursors, and any mixture thereof; preferably one or more sodium precursors.

With preference, the second aqueous suspension comprises at most 25 wt. % based on the total weight of the second aqueous suspension of one or more caesium precursors; preferably at most 20 wt. %; more preferably at most 15 wt. %; even more preferably at most 10 wt. %; and most preferably at most 5 wt. %.

With preference, the second aqueous suspension comprises at least 1 wt. % based on the total weight of the second aqueous suspension of one or more caesium precursors; preferably at least 1.5 wt. %; more preferably at least 2 wt. %; even more preferably at least 2.5 wt. %; and most preferably at least 3 wt. %.

With preference, the second aqueous suspension comprises at most 35 wt. % based on the total weight of the second aqueous suspension of one or more additional precursors comprising one or more potassium precursors and one or more selected from sodium precursors, and/or lithium precursors; preferably at most 30 wt. %; more preferably at most 25 wt. %; even more preferably at most 20 wt. %; and most preferably at most 15 wt. %.

With preference, the second aqueous suspension comprises at least 9 wt. % based on the total weight of the second aqueous suspension of one or more additional precursors comprising one or more potassium precursors and one or more selected from sodium precursors, and/or lithium precursors; preferably at least 10 wt. %; more preferably at least 11 wt. %; even more preferably at least 12 wt. %; and most preferably at least 13 wt. %.

With preference, the second aqueous suspension comprises from 9 to 35 wt. % based on the total weight of the second aqueous suspension of one or more additional precursors comprising:
from 1 wt. % to 13 wt. % based on the total weight of the second aqueous suspension of one or more potassium precursors; and
from 8 wt. % to 22 wt. % based on the total weight of the second aqueous suspension of one or more selected from one or more sodium precursors, one or more lithium precursors, and any mixture thereof; preferably one or more sodium precursors.

More preferably, the second aqueous suspension comprises from 12 to 32 wt. % based on the total weight of the second aqueous suspension of one or more additional precursors comprising:
from 2 wt. % to 12 wt. % based on the total weight of the second aqueous suspension of one or more potassium precursors; and
from 10 wt. % to 20 wt. % based on the total weight of the second aqueous suspension of one or more selected from one or more sodium precursors, one or more lithium precursors, and any mixture thereof; preferably one or more sodium precursors.

In one instance, the second aqueous suspension comprises water and:
23.26 wt. % based on the total weight of the second aqueous suspension of one or more silicate precursors;
2.18 wt. % based on the total weight of the second aqueous suspension of one or more caesium precursors;
3.99 wt. % based on the total weight of the second aqueous suspension of one or more potassium precursors; and
14.10 wt. % based on the total weight of the second aqueous suspension of one or more selected from one or more sodium precursors, one or more lithium precursors, and any mixture thereof; preferably one or more sodium precursors.

It is preferred that the weight ratio of the aqueous suspension containing one or more aluminate precursors over the aqueous suspension containing one or more silicate precursors is comprised between 0.25 and 1.5, preferably between 0.30 and 1.45, more preferably between 0.35 and 1.40, even more preferably between 0.40 and 1.35, most preferably between 0.50 and 1.25; wherein the aqueous suspension containing aluminate precursors is the aluminate precursor aqueous suspension or the first aqueous suspension; and the aqueous suspension containing silicate precursors is second aqueous suspension or the silicate precursor aqueous suspension respectively.

In another preferred embodiment, the dropwise addition of the aqueous suspension containing one or more aluminate precursors over the aqueous suspension containing one or more silicate precursors is performed in a temperature comprised between −5° C. and 25° C., preferably in a temperature comprised between 20° C. and 25° C. Advantageously, the dropwise addition of the aqueous suspension containing one or more aluminate precursors over the aqueous suspension containing one or more silicate precursors is performed under stirring, preferably under stirring of at least 500 rpm, more preferably of at least 750 rpm.

In yet another preferred embodiment, the dropwise addition of the aqueous suspension containing one or more silicate precursors onto the aqueous suspension containing one or more aluminate precursors is performed in a temperature comprised between 15° C. and 25° C. Advantageously, the dropwise addition of the aqueous suspension containing one or more silicate precursors onto the aqueous suspension containing one or more aluminate precursors is performed under stirring, preferably under stirring of at least 500 rpm, more preferably of at least 750 rpm.

### The Precursor of the Chabazite-Type Zeolite

The disclosure also provides the precursor of the chabazite-type zeolite. The precursors of the chabazite-type zeolite are obtainable by the method for the preparation of amorphous precursors of chabazite-type zeolite described above. The precursor is amorphous and has a molar composition comprising
a SiO₂:b Al₂O₃:c M¹₂O:d K₂O:e Cs₂O:f H₂O,

wherein a, b, c, d, e, and f are coefficient; and wherein

the coefficient a is ranging from at least 10.0 and at most 20.0;

the coefficient b is ranging from at least 0.3 and at most 2.5;

the coefficient c is ranging from at least 5.0 and at most 11.0;

the coefficient d is ranging from at least 0.7 and at most 1.6;

the coefficient e is ranging from at least 0.05 and at most 0.60; and

the coefficient f is ranging from at least 60 and at most 200

wherein M¹ is selected from Na and/or Li.

For example, the precursor is amorphous and has a molar composition comprising
a SiO₂:b Al₂O₃:c M¹₂O:d K₂O:e Cs₂O:f H₂O,

wherein a, b, c, d, e, and f are coefficient; and wherein

10.0≤a≤16.0;

0.5≤b≤2.5;

6.0≤c≤10.0;

0.8≤d≤1.6;

0.05≤e≤0.60; and

90≤f≤190;

wherein M¹ is selected from Na and/or Li.

According to the disclosure, the said molar composition is devoid of an organic structure-directing agent.

The amorphous precursors do not contain any seeds of a previously formed crystal of chabazite zeolite. No organic structure-directing agent is present either. The amorphous precursor of chabazite zeolite is fluoride-free. The chemical composition of the precursor suspension has been controlled to avoid the formation of side crystalline phases, such as ANA (pollucite), EDI, RHO, FAU and/or BPH. Additional control of the crystallization temperature will prevent the generation of these side crystalline phases.

The (M¹O+Cs₂O+K₂O)/SiO₂ ratio and the (M¹₂O+Cs₂O)/SiO₂ ratio provide guidance to select the content of cations in the precursor which influence the size of the nanocrystals. Per the disclosure, the .M¹₂O+Cs₂O+K₂O)/SiO₂ ratio and the (M¹₂O+Cs₂O)/SiO₂ ratio can be selected as followed.

For example, the (M¹₂O+Cs₂O)/SiO₂ ratio is at least 0.25 wherein M¹ is selected from Na and/or Li; preferably at least 0.30, more preferably at least 0.35, even more preferably at least 0.40, most preferably at least 0.50, even most preferably at least 0.55. Thus, in a preferred embodiment, M¹₂O is Na2O; the (Na₂O+Cs₂O)/SiO₂ ratio is at least 0.25, preferably at least 0.30, more preferably at least 0.35, even more preferably at least 0.40, most preferably at least 0.50, even most preferably at least 0.55.

For example, the (M¹₂O+Cs₂O)/SiO₂ ratio is ranging from 0.25 to 1.25, preferably from 0.30 to 1.20, more preferably from 0.35 to 1.15, even more preferably from 0.40 to 1.10, most preferably from 0.45 to 1.05. Thus, in a preferred embodiment, M¹₂O is Na₂O; the (Na₂O+Cs₂O)/SiO₂ ratio is ranging from 0.25 to 1.25, preferably from 0.30 to 1.20, more preferably from 0.35 to 1.15, even more preferably from 0.40 to 1.10, most preferably from 0.45 to 1.05.

For example, the (M¹₂O+Cs₂O+K₂O)/SiO₂ ratio is at least 0.55 wherein M¹ is selected from Na and/or Li, preferably is ranging from 0.55 to 1.00; more preferably from 0.58 to 0.95 and even more preferably from 0.60 to 0.90. Thus, in a preferred embodiment, M¹₂O is Na₂O; the (Na₂O+Cs₂O+K₂O)/SiO₂ ratio is at least 0.55, preferably is ranging from 0.55 to 1.00; more preferably from 0.58 to 0.95 and even more preferably from 0.60 to 0.90.

The ratio M¹₂O/H₂O provides guidance to select the content of water in the precursor which influence the size of the nanocrystals.

For example, the ratio M¹₂O/H₂O is superior or equal to 0.025, preferably superior or equal to 0.03, more preferably superior or equal to 0.04, even more preferably superior or equal to 0.05. The ratio M¹₂O/H₂O is the ratio c/f. Thus, in a preferred embodiment, M¹₂O is Na₂O; the ratio Na₂O/H₂O is superior or equal to 0.025, preferably superior or equal to 0.03, more preferably superior or equal to 0.04, even more preferably superior or equal to 0.05.

For example, the ratio M¹₂O/Al₂O₃ is superior or equal to 4.0, preferably superior or equal to 7.0, more preferably superior or equal to 7.5. The ratio M¹₂O/Al₂O₃ is the ratio c/b. Thus, in a preferred embodiment, M¹₂O is Na₂O; the ratio Na₂O/Al₂O₃ is superior or equal to 4.0, preferably superior or equal to 7.0, more preferably superior or equal to 7.5.

For example, the ratio Cs₂O/Al₂O₃ is inferior or equal to 0.90, preferably inferior or equal to 0.80, more preferably inferior or equal to 0.75, even more preferably inferior or equal to 0.60. The ratio Cs₂O/Al₂O₃ is the ratio e/b.

In a preferred embodiment, M¹₂O is or comprises Na₂O.

Advantageously, the coefficient a, attributed to the molar amount of silica, is equal to 10 or 16. It is preferred that the coefficient b, attributed to the molar amount of alumina is ranging between 0.70 and 2.30, more preferably is ranging between 0.80 and 2.20, even more preferably is equal to 0.70 or 0.80, most preferably is equal to 0.8.

With preference, the Si/Al molar ratio of the amorphous precursor of chabazite-type zeolite is comprised between 2 and 16.

With preference, the coefficient c, preferably attributed to the molar amount of sodium oxide, is ranging between 6.5 and 9.5, more preferably between 7.5 and 8.5, even more preferably is equal to 9.5.

With preference, the coefficient d, preferably attributed to the molar amount of potassium oxide, is ranging between 1.00 and 1.50, more preferably between 1.10 and 1.40, even more preferably between 1.20 and 1.30, most preferably is equal to 1.25.

With preference, the coefficient e, preferably attributed to the molar amount of caesium oxide, is ranging between 0.15 and 0.50, more preferably between 0.25 and 0.40, even more preferably between 0.30 and 0.35, preferably is equal to 0.15.

With preference, the coefficient f, attributed to the molar amount of water, is ranging between 100 and 180, more preferably between 120 and 160, even more preferably between 130 and 140, most preferably is equal to 140.

In a more preferred embodiment, when the coefficient a, attributed to the molar amount of silica, is equal to 10, then
0.6≤b≤0.8; with preference b=0.8;
6.0≤c≤8.0; with preference c=8.0;
1.25≤d≤1.35; with preference d=1.35;
0.20≤e≤0.30; with preference e=0.30; and
120≤f≤190; with preference f=120 or alternatively f=190.

The amorphous precursors with this molar composition are, after stirring, in a clear aqueous suspension and have a trend, when crystallized, to lead to nanocrystals which are going to agglomerate together. After crystallization, the resulting nanocrystals have an average crystal size comprised between 5 nm and 200 nm as determined by the Scherrer equation and they aggregate into aggregates having a size comprised between 400 nm and 2000 nm, as determined by Scanning Electron Microscopy. The agglomerates can be flake-like, which is very interesting when the chabazite-type zeolite is to be used in membrane application. In another more preferred embodiment, when the coefficient a, attributed to the molar amount of silica, is equal to 16, then
b=0.8;
9.0≤c≤9.5
d=0.85;
e=0.35; and
120≤f≤140.

The amorphous precursors with this molar composition are milky and have a trend to lead to nanocrystals, in particular to monodispersed discrete chabazite-type zeolite. After crystallization, the resulting nanocrystals have an average crystal size comprised between 130 nm and 200 nm as determined by the Scherrer equation.

In another more preferred embodiment, when the coefficient a, attributed to the molar amount of silica, is equal to 16, then
0.4≤b≤0.6;
c=6.0;
d=1.35;
0.15≤e≤0.25; with preference e=0.15; and
130≤f≤150.

The amorphous precursors with this molar composition are milky and have a trend to lead to smaller nanocrystals, in particular to a monodispersed discrete chabazite-type zeolite having an average crystal size comprised between 5 nm and 130 nm, as determined by the Scherrer equation.

### Method for Preparing the Chabazite-Type Zeolite From the Precursor

The disclosure provides a method for the preparation of chabazite-type zeolite, comprising the method for the preparation of an aqueous amorphous precursor of chabazite-type zeolite as described above and further comprising the following steps:
e) mixing said amorphous precursor under stirring and/or orbital shaking;
f) optionally, adding an additional silicate precursors aqueous suspension and mixing said amorphous precursor under stirring and/or orbital shaking;
g) heating said amorphous precursor at a temperature comprised between 90° C. and 160° C. such as to form one or more crystals of chabazite-type zeolite;
h) cooling down said one or more crystals of chabazite-type zeolite at a temperature comprised between 20° C. and 25° C.,
i) dispersing said one or more crystals of chabazite-type zeolite in water.

The mixing is performed by maintaining the suspension at room temperature (e.g., between 20° C. and 25° C.) in a closed space to avoid the water vapour. This temperature should be maintained for a time sufficient to favour the nucleation and to reduce the agglomeration of the amorphous nanoparticles of precursors in the crystalline phase. The pressure of the mixing step is preferably 0.1 MPa. The mixing is preferably carried out for a period comprised between 15 hours and 15 days, more preferably for at least 20 hours and/or at most 15 days and is preferably carried out under mechanical stirring, for instance at 700 rpm.

As some synthesis need an addition of silica precursor to prevent the formation of big amorphous particles and sedimentation, an additional silicate precursors aqueous suspension is added during the mixing step (e). When this is done, this is carried out after a period comprised between 4 and 7 days after the start of the mixing step (e). The amount of the additional silicate precursors aqueous suspension added in step (f) when said step (f) is carried out corresponds to an amount comprised between 50 wt. % and 70 wt. % of the amount of the silicate precursors suspension, preferably between 55 wt. % and 65 wt. %, more preferably is 60 wt. %. The one or more silicate precursors of the additional silicate precursors aqueous suspension are different or the same as the one or more silicate precursors of the silicate precursors aqueous suspension. The one or more silicate precursors of the additional silicate precursors aqueous suspension are selected among colloidal silica, silica oxyhydroxide species, silica hydrogel, silicic acid, fumed silica, tetraalkyl orthosilicates, silica hydroxides, precipitated silica, clays and a mixture thereof, preferably the silicate precursor of the third aqueous suspension is colloidal silica. The one or more silica precursors of the additional silicate precursors aqueous suspension are present in an amount comprised between 20 wt. % and 70 wt. % of the total weight of the additional silicate precursors aqueous suspension, preferably between 25 wt. % and 60 wt. %, more preferably between 28 wt. % and 50 wt. %, even more preferably is 30 wt. %. The additional silicate precursors aqueous suspension comprises water, preferably distilled water, more preferably double distilled water. The use of non-distilled water could afford a tiny amount of one or more chabazite-type zeolites with different counter-cations. The mixing step in step (f) is similar to the mixing step (e) and is required to obtain a homogeneous solution. However, the mixing step in step (f) is carried out during a shorter period that the mixing step (e), for example, the mixing step in step (f) is carried out for 1 hour. Once the solution has been mixed, the homogeneous solution obtained is crystallized to generate the chabazite-type zeolite. The heating step (g) is thus preferably performed at a temperature comprised between 100° C. and 150° C., preferably between 110° C. and 140° C., more preferably between 120° C. and 130° C. It is highlighted that if crystallization temperature is too low (below 90° C.) or if the crystallization temperature is too high (above 160° C.), the crystallization can provide other crystalline zeolite phases, such as ANA (pollucite), EDI, RHO, FAU and/or BPH. The crystallization is also performed in the absence of seed crystals. The crystallization is preferably carried out for a period comprised between 0.5 hour and 15 hours, more preferably between 2 hours and 12 hours, even more preferably between 7 hours and 11 hours, most preferably between 8 hours and 10 hours. The crystallization is preferably carried out in a sealed environment. After the crystallization has been carried, the nanocrystals must be cooled down at room temperature to control the size of the nanocrystals.

In a preferred embodiment, a step of recovering said one or more crystals of chabazite zeolite is performed once the nanocrystals have been cooled down and dispersed in water, preferably in distilled water, more preferably in double-distilled water. This performed by performing a washing step with the addition of water until the decanting water reaches a slightly basic pH, namely at least 7.5, followed by separation (either by filtration or by centrifugation or both). The nanocrystals are then dried, for instance in a conventional oven at a temperature of at least 50° C., preferably of at 80° C. A freeze-drying step is optionally carried out to remove the traces of water. The freeze-drying step is performed at a temperature comprised between −100° C. and −70° C., preferably between −92° C. and −76° C.

In a yet another preferred embodiment, the nanocrystals of chabazite can be ion-exchanged. This is carried out in presence of one salt, the cation of said salt being selected from the alkali metals, the alkaline earth metal, or ammonium; and the anion of said salt is selected from halogens or nitrate, preferably from chloride or nitrate. The protonic form of the nanocrystals of chabazite can also be produced.

### The Chabazite-Type Zeolite

The disclosure provides a chabazite-type zeolite, comprising at least two cages composed of 4- and 8-membered rings connected by one 6-membered double ring, remarkable in that it has a Si/Al molar ratio comprised between 1 and 15 as determined by ²⁹Si magic angle spinning nuclear magnetic resonance, said chabazite-type zeolite comprises caesium and potassium with a Cs/K molar ratio of at most 5.0 as determined by Inductively Coupled Plasma Optical Emission Spectrometry; and said chabazite-type zeolite forms nanoparticles with an average crystal size comprised between 5 nm and 250 nm as determined by the Scherrer equation and with a specific surface area comprised between 50 m² g⁻¹ and 200 m² g⁻¹, as determined by N₂ sorption measurements.

The nanoparticle has a specific surface area preferably comprised between 60 m² g⁻¹ and 190 m² g⁻¹ as determined by N₂ adsorption measurements; preferably 75 m² g⁻¹ and 175 m² g⁻¹; more preferably comprised between 100 m² g⁻¹ and 150 m² g⁻¹

For example, the Si/Al molar ratio as determined by ²⁹Si magic angle spinning nuclear magnetic resonance is at least 1.0 or at least 1.1, preferably at least 1.2 or at least 1.25, more preferably at least 1.4 or at least 1.5; more preferably at least 1.9; even more preferably at least 2.1 and most preferably at least 2.4.

For example, the Si/Al molar ratio as determined by ²⁹Si magic angle spinning nuclear magnetic resonance is at most 10, preferably at most 8, more preferably at most 5; even more preferably at most 4, most preferably at most 3.0 and even most preferably at most 2.9, or at most 2.8 or at most 2.7, or at most 2.6.

It is preferred that the chabazite-type zeolite has a Si/Al molar ratio comprised between 1.10 and 3.00, more preferably comprised between 1.25 and 2.60, even more preferably between 1.40 and 2.40, most preferably between 1.50 and 2.10.

For example, the Cs/K molar ratio is at most 4.0 as determined by Inductively Coupled Plasma Optical Emission Spectrometry, preferably at most 3.0; more preferably at most 2.5; even more preferably at most 2.0, and more preferably at most 1.9 and at most 1.8

For example, the Cs/K molar ratio is at least 0.1 as determined by Inductively Coupled Plasma Optical Emission Spectrometry; preferably at least 0.2, more preferably at least 0.3; even more preferably at least 0.4 and most preferably at least 0.5.

For example, the chabazite-type zeolite has an M¹/Al molar ratio ranging from 0.02 to 0.20 wherein M¹ is selected from Na and/or Li; as determined by Inductively Coupled Plasma Optical Emission Spectrometry; preferably from 0.05 to 0.15; more preferably from 0.075 and 0.12.

For example, the chabazite-type zeolite has a Na/Al molar ratio ranging from 0.02 to 0.20 as determined by Inductively Coupled Plasma Optical Emission Spectrometry; preferably from 0.05 to 0.15; more preferably from 0.075 and 0.12.

For example, the chabazite-type zeolite has an M¹/Cs molar ratio ranging from 0.10 to 0.50 wherein M¹ is selected from Na and/or Li, as determined by Inductively Coupled Plasma Optical Emission Spectrometry preferably from 0.14 to 0.40; more preferably from 0.17 and 0.30.

For example, the chabazite-type zeolite has a Na/Cs molar ratio ranging from 0.10 to 0.50 wherein M¹ is selected from Na and/or Li, as determined by Inductively Coupled Plasma Optical Emission Spectrometry preferably from 0.14 to 0.40; more preferably from 0.17 and 0.30.

For example, the chabazite-type zeolite has a Cs/Al molar ratio comprised between 0.15 and 0.45, preferably between 0.20 and 0.40, more preferably between 0.21 and 0.39, even more preferably between 0.22 and 0.38.

In an embodiment, the zeolite consists of Al, Si, O, K, Cs and M¹ wherein M¹ is selected from Na and/or Li.

In an embodiment, the zeolite is ion-exchanged and consists of Al, Si, Cs, O, H and K.

Advantageously, the average crystal size of the nanoparticles is comprised between 10 nm and 245 nm as determined by the Scherrer equation, preferably between 15 nm and 235 nm, more preferably between 20 nm and 225 nm, even more preferably between 50 nm and 220 nm, most preferably between 80 nm and 200 nm, even most preferably between 90 nm and 145 nm. The average crystal size of the nanoparticles is at least 10 nm and at most 250 nm as determined by the Scherrer equation, preferably at most 200 nm, more preferably at most 195 nm, even more preferably at most 185 nm, most preferably at most 175 nm, even most preferably at most 165 nm.

The chabazite-type zeolites of the present disclosure are therefore downsized and/or nanosized. They thus provide high accessibility when used as catalysts and provide fast diffusion of the interacting components. Moreover, their size is advantageous for being highly stable into suspensions.

The pore volume of the chabazite-type zeolite has been determined by N₂ sorption measurements and is comprised between 0.10 cm³ g⁻¹ and 0.50 cm³ g⁻¹, preferably between 0.20 cm³ g⁻¹ and 0.40 cm³ g⁻¹, more preferably between 0.25 cm³ g⁻¹ and 0.35 cm³ g⁻¹. The pore volume is thus accessible to nitrogen.

Said nanoparticles have an average pore size diameter comprised between 3.72 Å and 4.20 Å, as determined by Brunauer-Emmet-Teller experiments, preferably of 3.80 Å.

The pore volume of the chabazite-type zeolite has been determined by N₂ sorption measurements and is comprised between 0.10 cm³ g⁻¹ and 0.50 cm³ g⁻¹, preferably between 0.20 cm³ g⁻¹ and 0.40 cm³ g⁻¹, more preferably between 0.25 cm³ g⁻¹ and 0.35 cm³ g⁻¹. The pore volume is N₂ accessible.

Preferably, the chabazite-type zeolite comprises at least one 8-membered ring channel.

In a first preferred embodiment, the chabazite-type zeolite forms monodispersed nanoparticles preferably monodispersed nanoparticles comprising single nanocrystals.

In a second preferred embodiment, alternative to the first preferred embodiment, the chabazite-type zeolite forms aggregates, preferably aggregates of nanocrystals. The aggregates have a size preferably ranging between 400 nm and 2000 nm as determined by Scanning Electron Microscopy, more preferably between 450 nm and 1800 nm, even more preferably between 500 nm and 1700 nm, most preferably between 550 nm and 1600 nm, even most preferably between 600 nm and 1500 nm. The aggregates have preferably a size of at least 400 nm and/or of at most 2000 nm as determined by Scanning Electron Microscopy, more preferably of at least 600 nm, even more preferably of at least 650 nm, most preferably of at least 1000 nm, even most preferably of at least 1600 nm, and/or preferably of at most 1800 nm, more preferably of at most 1600 nm, even more preferably of at most 1000 nm, most preferably of at most 650 nm, even most preferably of at most 600 nm.

In yet another preferred embodiment, the chabazite-type zeolite forms aggregated nanocrystals forming spheroidal particles and/or flake-shape particles.

### The Use of the Chabazite-Type Zeolite

The disclosure provides for a use of the chabazite zeolite as defined in accordance with the first aspect of the disclosure as a sorbent for carbon dioxide. Selective separation of carbon dioxide from methane has been achieved in a multi-cycle adsorption/desorption steps. With preference, the use is made in a process for separation of carbon dioxide from methane or in a process for separation of carbon dioxide from an inert gas such as N₂, He and/or Ar.

The disclosure provides for a use of the chabazite-type zeolite as described above as a sorbent of carbon dioxide. The low Si/Al molar ratio, which allows for high content of cation, reduces the accessibility of nitrogen (having a diameter of 3.6 Å) and of methane (having a diameter of 3.8 Å) while the carbon dioxide (being smaller, with a diameter of 3.3 Å) can be adsorbed and desorbed with the chabazite-type zeolite of the present disclosure In addition to the size of the molecules, the electronic interactions and/or the electronic repulsion play an essential role in the possibility of the molecule to displace the cations to enter the zeolite.

The disclosure also provides for a use of the chabazite-type zeolite as described above in a method of preparing clathrate hydrate substance, wherein said clathrate hydrate substance entraps preferably methane. The chabazite-type zeolite is contacted with a gaseous water feed and a gaseous material, for instance methane, under determined conditions of temperature and pressure. In this instance, methane can thus be entrapped into a lattice of water and forming thus a clathrate hydrate entrapping methane.

Further use of the chabazite-type zeolite as described above is its use as a catalyst in a chemical process. For instance, said chemical process can be the conversion of methyl halides to olefins, the conversion of sulfurized hydrocarbons to olefins, the partial oxidation of methane, the oligomerizing of alkenes, the carbonylation of dimethyl ether with carbon monoxide, the methylation of amines, a cracking process, a dehydrogenating process, the isomerization of olefins, or a reforming process.

### Test and Determination Methods

The various chabazite-type zeolites obtained in the examples were characterized over the following methods and after a step of drying which is performed at a temperature of at least 50° C., preferably at 80° C. in a conventional oven.

Powder X-ray diffraction (XRD) analysis, carried out on powder samples of the synthetic chabazite, was performed using a PANalytical X'Pert Pro diffractometer with CuKα monochromatized radiation (λ=1.5418 Å, 45 kV, 40 mA). The samples were scanned in the range 5-50° 2θ with a step size of 0.02°.

Unit cell parameters of chabazite particles were determined from the powder X-Ray diffraction data by calculation based on a Le Bail profile refinement and pseudo-Voigt profile function using the JANA2006 software. In addition, a progressive Rietveld refinement to minimize the differences between the pattern observed and the calculated one with structural models was carried out to solve and quantify the framework and extra-framework structure (structural type and atomic positions) using JANA2006 software.

In situ Powder X-ray diffraction (XRD) analysis was carried out to follow CO₂ sorption in chabazite samples, using a PANalytical X'Pert Pro diffractometer with CuKα monochromatized radiation (λ=1.5418 Å). The samples were scanned in the range 5-110° 2θ with a step size of 0.02°. The samples were in situ activated at 350° C. for 2 h to remove the adsorbed water. The activation and measurements were carried out at identical conditions to those applied in the TG experiments. The CO₂ flow (1bar) was delivered at 350° C., and the measurements were performed under continuous delivery of CO₂ and decrease of temperature to 30° C. (20 K min⁻¹). For the cycling procedure, the sample was re-activated at 350° C. for 1 h (ramp: 5K min⁻¹) and then the adsorption procedure for CO₂ was repeated one more time.

The Scherrer equation links the broadening of the XRD peaks to the size of the crystallites. It has been used to quantify the size of crystals in powder form using powder XRD pattern and X-Pert software. The first Bragg peak of the XRD pattern is usually taken into consideration.

Transmission electron microscopy (TEM) was carried out determine the crystal size, morphology and crystallinity of solids using a JEOL 2010 FEG or TECHNAI operating at 200 kV.

Scanning electron microscopy (SEM) analysis was used to determine the surface state, morphology and particle size, using a field-emission scanning electron microscope (SEM, Philips XL30 FEG) with an accelerating voltage 10-30 kV.

Inductively coupled plasma (ICP) optical emission spectrometry was used to determine the chemical compositions using a Varian ICP-OES 720-ES. The Cs/K molar ratio, the Cs/Al molar ratio, the M¹/Cs molar ratio, the Na/Al molar ratio and the Na/Cs molar ratio of the chabazite-type zeolite have thus been determined using this technical method.

Energy-dispersive X-ray Transmission Electron Microscopy (EDX-TEM) was used to determine the chemical compositions using a JEOL Model 2010 FEG system fitted with an EDX analyser operating at 200 kV on diluted colloidal suspensions of zeolite materials obtained either after step (f) or after the drying step, that was sonicated for 15 min. Then 2-3 drops of fine particle suspensions were dried on carbon-film-covered 300-mesh copper electron microscope grids. EDX-TEM is an alternative method to determine the composition of the zeolite such as the Cs content or the molar ratios such as the Cs/Al molar ratio. In such a case, at least ten analysis of the same zeolite material at different TEM spots are averaged to obtain the chemical composition of the zeolite materials. The Si/Al molar ratio, the Cs/K molar ratio, the Cs/Al molar ratio, the M1/Cs molar ratio, the Na/Al molar ratio and the Na/Cs molar ratio of the chabazite-type zeolite can be determined using this technical method.

Nuclear Magnetic Resonance (NMR) analysis was performed to determine the crystallinity and the Si/Al molar ratio of the zeolite materials obtained after the drying step. NMR spectrum was determined by ²⁹Si and solid-state magic angle spinning (MAS) NMR on a Bruker Avance III-HD 500 (11.7 T) spectrometer operating at 99.3 MHz, using 4-mm outer diameter zirconia rotors spun at 12 kHz. ²⁹Si chemical shift was referenced to tetramethylsilane (TMS). The molecular geometry of aluminium was determined using ²⁷Al MAS NMR on a Bruker Avance III-HD 500 (11.7 T) spectrometer using 4-mm outer diameter zirconia rotors spun at 14 kHz. ²⁷Al chemical shift was referenced to aluminium ammonium sulphate.

The ²⁹Si chemical shift sensitivity is an indication of the degree of condensation of the Si—O tetrahedra, that is, the number and type of tetrahedrally coordinated atoms connected to a given SiO₄ unit. Furthermore, ²⁹Si MAS NMR spectra can be used to calculate the Si/Al molar ratio from the NMR signal intensities (I) according to eq. (1):

$$\frac{Si}{Al} = \frac{{\sum }_{n = 0}^{4} {I}_{Si ( nAl )}}{{\sum }_{n = 0}^{4} 0.25 {nI}_{Si ( nAL )}} \qquad ( 1 )$$

wherein n indicates the number of Al atoms sharing the oxygen atom of the SiO₄ tetrahedron under consideration and wherein n=0, 1, 2, 3 or 4.

The chemical shift range of the silicon atom is comprised between −80 ppm to −115 ppm, with the high-field signal for the silicon atom directly linked to the oxygen atom of the —O—Al moiety. The differences in chemical shifts between Si (n Al) and Si (n+1 Al) are about 5-6 ppm in the low-field signal.

N₂ sorption analysis was used to determine the nitrogen adsorption/desorption isotherms using Micrometrics ASAP 2020 volumetric adsorption analyser. The samples were degassed at 350° C. under vacuum overnight before the measurement. From these measurements, the pore volume of the chabazite-type zeolite has been determined.

ζ-potential curve is was carried out to determine the stability of nanozeolites (dispersed particles) in water (dispersion medium) using a Malvern Zetasizer Nano Instrument.

Thermogravimetry analyses (TGA) and Differential Thermal analysis (DTA) were performed on zeolite nanocrystals obtained when the step (f) of recovering said one or more crystals of CHA-type zeolite is performed (before drying). TGA and DTA were carried out on a SETSYS 1750 CS evolution instrument (SETARAM). The sample was heated from 25° C. to 800° C. with a heating ramp of 5° C./min under carbon dioxide or nitrogen (flow rate: 40 mL/min).

After activation (water desorption) at 350° C. for 2 hours, the zeolitic material was allowed to return and stay at room temperature under a continuous flow of CO₂ (flow rate: 40 mL/min, 1 bar) in 9 hours. The quantity of CO₂ absorbed was determined using the mass increase compared to the total mass of the sample.

Cycles of CO₂ adsorption/desorption were conducted and monitored by TGA. An alternance between activation at 350° C. for 2 hours under N₂ flow (flow rate: 40 mL/min) and CO₂ adsorption at room temperature (flow rate: 40 mL/min, 1 barg) for 2 hours has been performed 10 consecutive times.

Carbon dioxide adsorption isotherms were measured using Micrometrics ASAP 2020 volumetric adsorption analyser. Samples after being dried and freeze-dried were degassed at 623 K under vacuum overnight before the measurement. This test was performed to evaluate the adsorption properties of the zeolites prepared according to the method of the disclosure.

Fourier Transformation Infra-Red (FTI R) spectroscopic analysis was conducted to characterize the selective adsorption of CO₂ and CH₄ with nanosized chabazite-type zeolite. The adsorption CO₂ on 23.18 g of self-supported pellets of as-prepared CHA zeolite was followed using in-situ FTIR spectroscopy. The infra-red cell was kept under high-vacuum (10⁻⁵ Pa). The sample was activated at 350° C. for 2 h to desorb the water before the measurements. The infra-red spectra from the chabazite samples under adsorption of CO₂ and CH₄ were collected at room temperature.

### EXAMPLES

The embodiments of the present disclosure will be better understood by looking at the different examples below.

The starting materials used in the examples presented below are listed as follow:
sodium hydroxide: (pellets, purity >99%): Sigma Aldrich;
potassium hydroxide (pellets, purity >85%): Sigma Aldrich;
caesium hydroxide (purity >98%, aqueous 50%): Alfa Aesar;
colloidal silica (Ludox-HS 30, 30 wt. % SiO₂, pH=9.8): Sigma Aldrich;
colloidal silica (Ludox-AS 40, 40 wt. % SiO2): Sigma Aldrich;
sodium aluminate (Al₂O₃ 53%, Na₂O 47% by mass): Sigma Aldrich

These starting materials were used as received from the manufacturers, without additional purification.

### Example 1: Synthesis of Agglomerated CHA Zeolite (Samples 1-9)

An aluminate precursors aqueous suspension was prepared by dissolving 0.512 g of NaAlO₂ in 3.34 g of double-distilled H2O. This suspension is clear.

A silicate precursors aqueous suspension was prepared in 4.97 g of double-distilled H₂O by mixing 6.667 g of colloidal silica (LUDOX® HS30) with 1.94 g of NaOH, 0.550 g of KOH, 0.599 g of CsOH (aq. 50%). As a result, a warm turbid suspension was obtained due to the exothermic reaction. The turbid turns into clear suspension after 10 minutes and it is stirred for additional 1h.

The aluminate precursors aqueous suspension was added dropwise under vigorously stirring to the silicate precursors aqueous suspension kept in ice. The weight ratio of the aluminate precursors aqueous suspension over the silicate precursors aqueous suspension is equal to 0.387.

The resulting clear suspension for sample 1 had the following molar compositions:

10 SiO₂:0.8 Al₂O₃:8 Na₂O :1.25 K₂O:0.3 Cs₂O :140 H₂O

This resulting clear suspension was then mixed during 20h at room temperature (e.g. 25° C.) under vigorous stirring (e.g. 800 rpm).

Then, the hydrothermal crystallization was conducted at 90° C. for 8 hours to obtain a different type of particles in term of size, morphology, chemical composition. The time of hydrothermal treatment depends on the temperature and the chemical composition.

The CHA zeolite samples were purified by repeating steps of centrifugation (20000 rpm for 20 min) and dispersed in distilled water until reaching pH=8, and then freeze-dried.

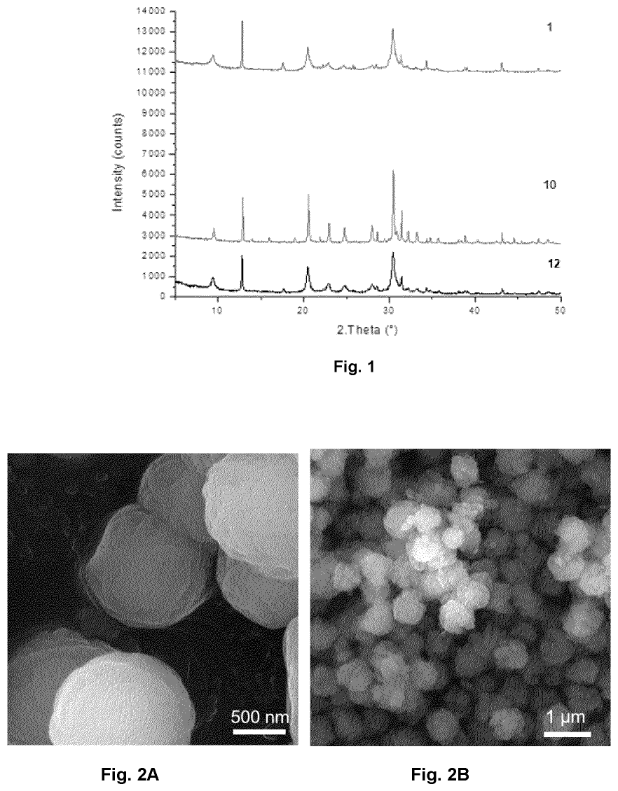

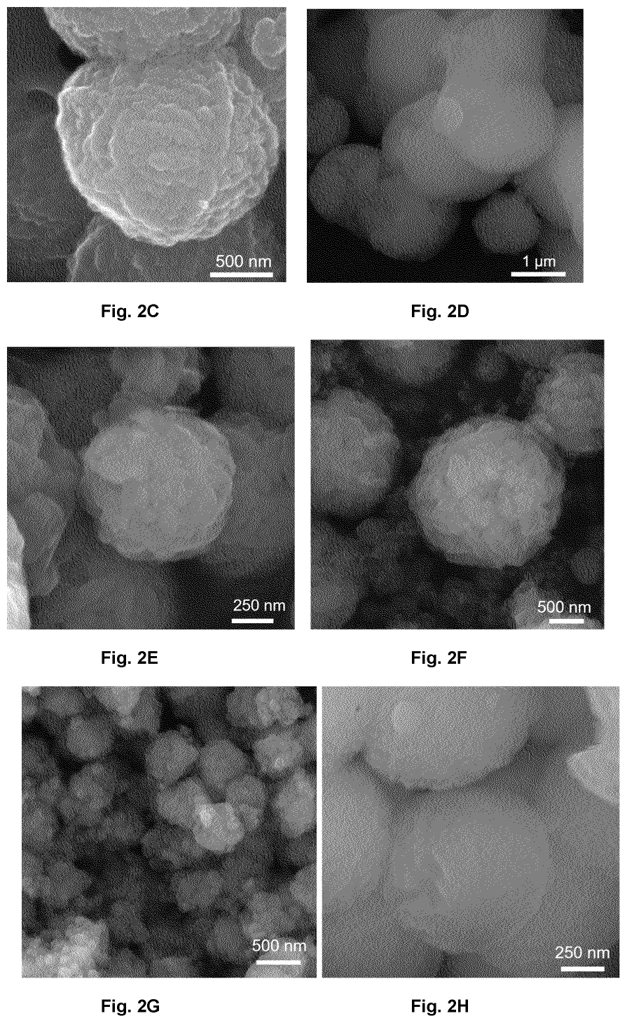

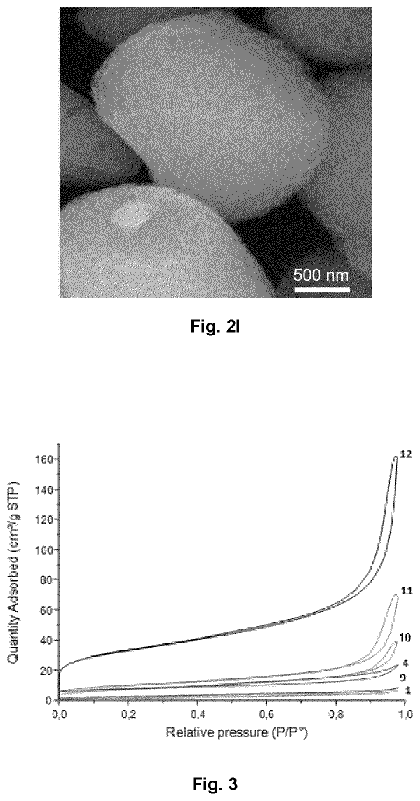

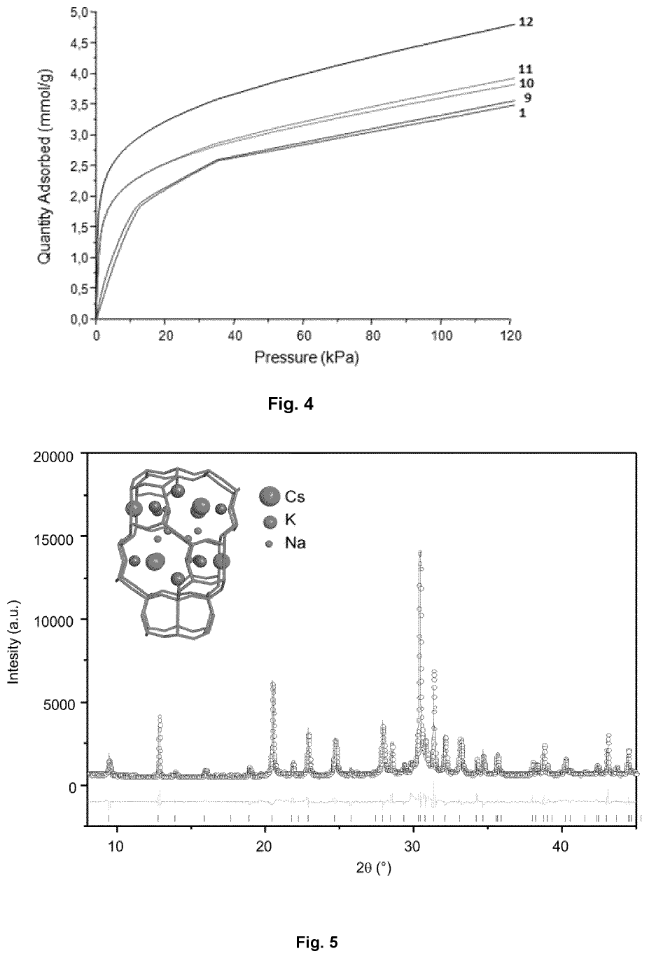

FIG. 1 shows the XRD pattern of the CHA zeolite sample 1. FIG. 2 shows the SEM images and FIG. 3 shows the N₂ adsorption-desorption isotherms of said CHA zeolite sample 1. FIG. 4 shows the corresponding CO₂ adsorption isotherm.

The molar composition for samples 1-8 of the clear suspension after addition of the first aqueous suspension to the second aqueous suspension has the following composition:

a SiO₂:b Al₂O₃:c Na₂O :d K₂O:e Cs₂O:f H₂O,

a=10.0

0.5≤b≤2.5;

6.0≤c≤10.0;

1.0≤d≤1.6;

0.05≤e≤0.60; and

90≤f≤150.

Samples 1-8 were obtained in a yield varying between 60% and 65%.

FIG. 3 shows respectively the N₂ adsorption-desorption isotherm of sample 4.

Sample 9 was prepared using the same conditions as for sample 1, except that 6.33 g of double-distilled H₂O was used to dissolve the 0.512 g of NaAlO₂.

The molar composition of the precursor mixture for sample 9 is:

(9) 10 SiO₂:0.8 Al₂O₃:8.0 Na₂O:1.35 K₂O:0.30 Cs₂O:190 H₂O

Sample 9 was obtained in a yield of 60%.

Table 1 summarizes the molar composition of the amorphous precursor mixture obtained for the samples 1-9.

TABLE 1
Molar composition of the amorphous precursor mixture obtained for
the 9 different samples prepared in accordance with example 1.

| | | | | | | | Mixing | | | |
|---|---|---|---|---|---|---|---|---|---|---|
| | | | | | | | time | Synthesis | | Synthesis |
| | SiO₂ | Na₂O | K₂O | Cs₂O | Al₂O₃ | H₂O | (day) | temperature | | time |
| 1 | 10 | 8 | 1.25 | 0.3 | 0.8 | 140 | 1 | 90° | C. | 8 h |
| 2 | 10 | 6 | 1.25 | 0.3 | 0.6 | 140 | 4 | 100° | C. | 2 h 45 |
| 3 | 10 | 6 | 1.35 | 0.2 | 0.8 | 140 | 1 | 100° | C. | 5 h |
| 4 | 10 | 8 | 1.35 | 0.2 | 0.6 | 140 | 4 | 90° | C. | 8 h |
| 5 | 10 | 6 | 1.35 | 0.2 | 0.8 | 120 | 4 | 90° | C. | 8 h |
| 6 | 10 | 8 | 1.35 | 0.2 | 0.6 | 120 | 1 | 100° | C. | 5 h |
| 7 | 10 | 8 | 1.25 | 0.3 | 0.8 | 120 | 4 | 100° | C. | 5 h |
| 8 | 10 | 6 | 1.25 | 0.3 | 0.6 | 120 | 1 | 90° | C. | 6 h |
| 9 | 10 | 8 | 1.25 | 0.3 | 0.8 | 190 | 1 | 90° | C. | 8 h |

The properties of the CHA zeolite samples (Si/Al molar ratio and the average size of crystals and agglomerates are summarized in table 2. The size of the crystals has been determined in the c direction from Scherrer's equation, namely in one of the directions that grow the fastest.

TABLE 2
Properties of the CHA zeolite samples 1-9.

| | Size of | Size of | |
|---|---|---|---|
| | crystals* | aggregates** | |
| Sample | nm | Nm | Si/Al |
| 1 | 136 | 1600 | 1.77 |
| 2 | 109 | 650 | 1.90 |
| 3 | 105 | 1800 | 1.75 |
| 4 | 233 | 1600 | 1.65 |
| 5 | 90 | 600 | 1.68 |
| 6 | 156 | 1800 | 1.58 |
| 7 | 222 | 450 | 1.71 |
| 8 | 107 | 1000 | 1.88 |
| 9 | 195 | 1800 | 1.90 |

*The average sizes of the crystallites in the (ab) plan were obtained from the X-Ray diffraction data using the Scherrer’s equation on the reflection [2, −1, 0] using the corresponding peak at 12.82°.
**Aggregates size determined by Scanning Electron Microscopy (direction ab)

Sample 9 reveals a higher Si/Al molar ratio (1.90) and bigger particles when compared to sample 1 (1.77) due to higher dilution.

The crystal shape is flake-like and the size is from 80 to 200 nm in the c direction and thickness of 50 nm (obtained from the Scherrer's equation using the Bragg peak at 9.35° 2θ). The flake-like shape of the crystal is very interesting in membrane application, for instance, sorption experiments.

FIGS. 3 and 4 show respectively the N₂ adsorption-desorption isotherms and the CO₂ adsorption isotherm of samples 9.

The chemical composition of the samples 1-9 has been determined by ICP analysis and is present in table 3.

TABLE 3
Chemical composition of samples 1-9 as well as
Si/Al and Cs/K molar ratios.

| Sample | Formula* | Si/Al | Cs/K |
|---|---|---|---|
| 1 | (Cs_{4.8}K_{4.9}Na_{3.6})Si_{22.7}Al_{13.3}O₇₂ | 1.77 | 0.98 |
| 2 | (Cs_{4.6}K_{3.9}Na_{5.3})Si_{22.2}Al_{13.8}O₇₂ | 1.67 | 1.18 |
| 3 | (Cs_{3.6}K_{6.0}Na_{3.8})Si_{22.6}Al_{13.4}O₇₂ | 1.75 | 0.60 |
| 4 | (Cs_{5.2}K_{5.1}Na_{3.7})Si_{22.0}Al_{14.0}O₇₂ | 1.63 | 1.02 |
| 5 | (Cs_{3.9}K_{6.0}Na_{3.9})Si_{22.2}Al_{13.8}O₇₂ | 1.68 | 0.65 |
| 6 | (Cs_{4.3}K_{5.0}Na_{5.1})Si_{21.6}Al_{14.4}O₇₂ | 1.56 | 0.86 |
| 7 | (Cs_{5.8}K_{4.8}Na_{2.4})Si_{23.0}Al_{13.0}O₇₂ | 1.84 | 1.21 |
| 8 | (Cs_{5.8}K_{4.3}Na_{2.7})Si_{23.2}Al_{12.8}O₇₂ | 1.88 | 1.35 |
| 9 | (Cs_{4.4}K_{4.9}Na_{3.4})Si_{23.3}Al_{12.7}O₇₂ | 1.90 | 0.90 |

*determination based on lop analysis

### Example 2: Synthesis of Monodispersed Discrete CHA Zeolite (Samples 10-11)

An aluminate precursors aqueous suspension was prepared by dissolving 0.546 g of NaAlO₂ in 3.242 g of double-distilled H2O. This suspension is clear. Then 2.264 g of NaOH, 0.374 g of KOH, 0.699 g of CsOH (aq. 50%) was added. As a result, a worm turbid suspension was obtained due to the exothermic process. The turbid suspension turns into clear suspension after 10 minutes, and it is stirred for 2 h.

A silicate precursors aqueous suspension was prepared by adding dropwise under vigorously stirring 7.667 g of colloidal silica (LUDOX® HS30) to the first aqueous suspension kept in ice. The weight ratio of the aluminate precursors aqueous solution over the silicate precursors aqueous solution is equal to 0.9.

The resulting milky suspension for samples 10 and 11 had the following molar compositions:

10 SiO₂:0.8 Al₂O₃:c Na₂O:0.85 K₂O:0.35 Cs₂O:f H₂O

9.0≤c≤9.5;

110≤f≤130;

This resulting milky suspension was then mixed during 7 days at room temperature (e.g. 25° C.) under vigorous stirring (e.g. 800 rpm).

Then 3 g of aqueous silicate (colloidal silica (LUDOX® HS30)) was added dropwise to increase de Si/Al molar ratio in the precursor suspension. Then the suspension is stirred for 1 hour at 650 rpm.

Then, the hydrothermal crystallization was conducted at 90° C. for 8 hours to obtain monodisperse nanoparticles of synthetic CHA zeolite.

Chabazite monocrystals were purified by three steps centrifugation (25,000 rpm for 4 h) followed by redispersion in water until the decanting water reached a pH of 7, and then freeze-dried before further characterization.

The Rietveld refinement data for sample 10 is shown in FIG. 5. The Rietveld method allows to “refine” the structural model taking into account the shape, the position and the intensity of the diffraction peaks. The good agreement between the experimental pattern and the calculated profile has confirmed the good quality of the proposed model.

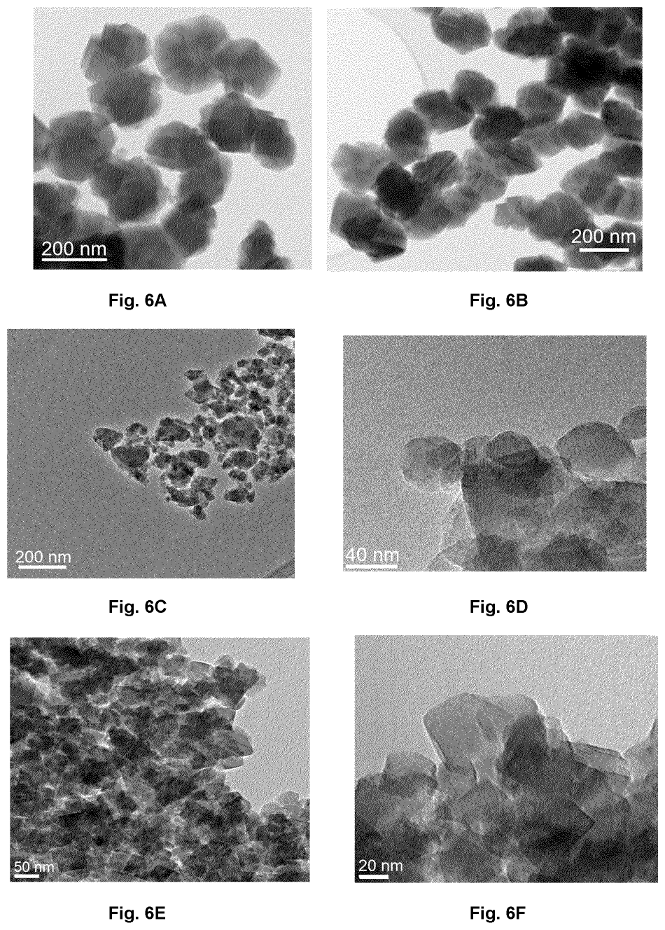

The TEM images at a magnification of 200 nm of sample 10 are depicted in FIGS. 6A and 6B.

The isotherms of samples 10 and 11 are shown in FIG. 3 (N₂ isotherms) and in FIG. 4 (CO₂ isotherms).

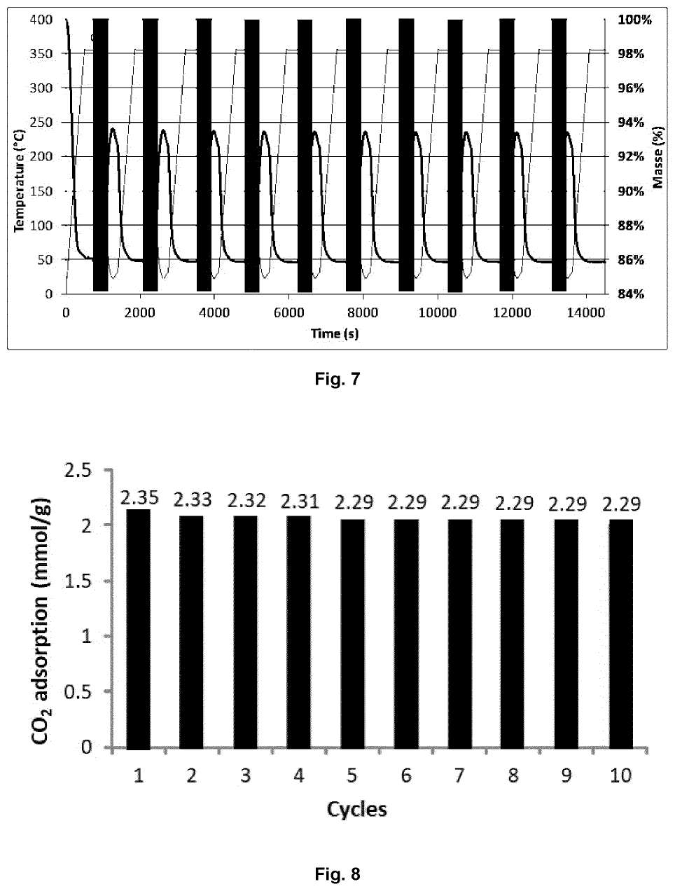

The sample 10 (26.91 g) was dehydrated at 350° C. for 1 h (ramp: 5K/min). The CO₂ flow (40 ml min⁻¹) was delivered at 350° C., and the measurements were performed under continuous delivery of CO₂ and decrease of temperature to 30° C. min⁻¹ (20K min⁻¹). For the cycling procedure, the sample was re-activated at 350° C. for 1 h (ramp: 5K min⁻¹) and then the adsorption procedure for CO₂ was repeated 9 times. The full reversibility of CO₂ absorption in sample 10 is demonstrated in FIGS. 7, 8 and 9.

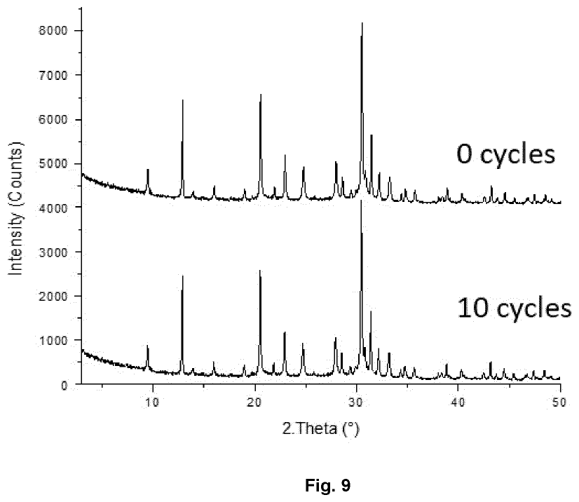

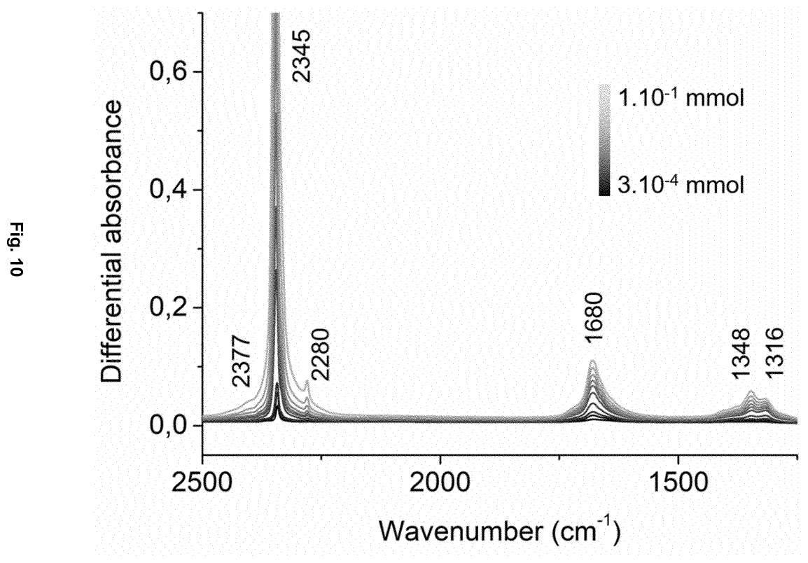

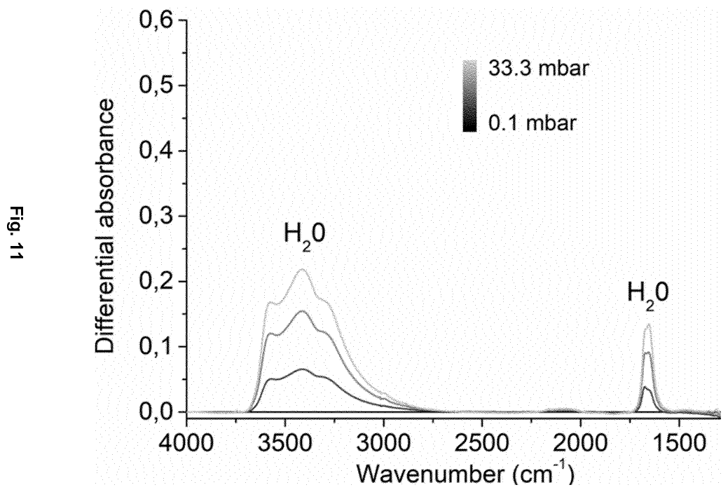

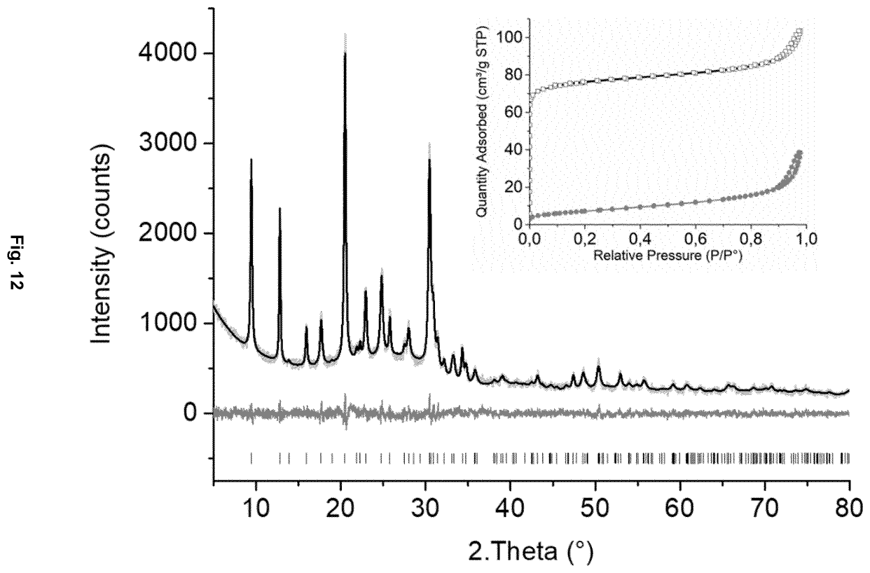

The adsorption capacity is not perturbed even after ten consecutive cycles as the band areas on FIG. 9 reach the same level in all cycles.

The results from the FTIR analysis performed under adsorption of CO₂ and CH₄ are respectively shown in FIGS. 10 and 11.

The multi-cycle adsorption-desorption step can be carried out ten consecutive times, each step lasting of 3 h20.

Table 4 reports the molar composition of the amorphous precursor mixture obtained for the samples 10 and 11, after that the extra amount silicate has been added.

TABLE 4
Molar composition of the amorphous precursor mixture obtained for
the 2 different samples prepared in accordance with example 2.

| | | | | | | | Mixing | | |
|---|---|---|---|---|---|---|---|---|---|
| | | | | | | | time | Synthesis | Synthesis |
| | SiO₂ | Na₂O | K₂O | Cs₂O | Al₂O₃ | H₂O | (days) | temperature | time |
| 10 | 16 | 9.5 | 0.85 | 0.35 | 0.8 | 140 | 7 + 10 | 90° C. | 7 h |
| 11 | 16 | 9 | 0.85 | 0.35 | 0.8 | 120 | 7 + 10 | 90° C. | 7 h |

The properties of the zeolite samples 10 and 11 are presented in Table 5.

TABLE 5
Properties of the CHA zeolite samples 10-11.

| | Si/Al molar | Crystals | CO₂ uptake |
|---|---|---|---|
| Sample | ratio | size (nm)* | (mmol g⁻¹)** |
| 10 | 2.13 | 170 | 3.82 |
| 11 | 2.03 | 153 | 3.91 |

*The average sizes of the crystallites in the (ab) plan were obtained from the X-Ray diffraction data using the Scherrer’s equation on the reflection [2, −1, 0] using the corresponding peak at 12.82°.
**BET experiments (At 0° C., 121 kPa; Static CO₂ isotherm adsorption).

Sample 10 has been ion-exchanged with NH₄NO₃. The material was ion-exchanged with a solution of 0.1 M of NH₄NO₃ for 20 h at room temperature (e.g. 25° C.). The resulting powder was washed twice by centrifugation (20,000 rpm). The procedure was repeated until a pH of 8 is obtained for the decanting water. Then the zeolite was washed with double-distilled H₂O, and calcined (e.g. at 400° C. for 2 h, ramp of 1° C. min⁻¹) to eliminate of the NH₃ and NOx and obtaining the acidic form of the chabazite zeolite sample 10.

The chemical composition of the parent sample 10 and the ion-exchanged sample 10 are given in table 6:

TABLE 6
Chemical composition of sample 10 before and after
ion-exchanged, determined based on ICP analysis.

| Sample 10 | Formula |
|---|---|
| Parent | (Cs_{6.3}K_{4.2}Na_{1.3})Si_{24.2}Al_{11.8}O₇₂ |
| Exchanged | (Cs_{0.6}K_{0.4}H_{10.6})Si_{24.2}Al_{11.8}O₇₂ |

FIG. 12 shows the XRD pattern and the N₂ sorption isotherms of ion-exchanged sample 10. The Le Bail refinement of ion-exchanged zeolite reveals a space group R-3m and a unit cell parameter of a=b=13.823 Ångströms and c=15.047 Ångströms. From the adsorption isotherm of N₂ of the as-prepared sample 10 (filled square on the insert of FIG. 12) and the sample in protonic form (empty square on the insert of FIG. 12), it is possible to determine the micropore volume for the sample in protonic form as being equal to 0.16 cm³ g⁻¹. The micropore volume of the sample which is ion-exchanged (with Na, Cs or K) is 0.06 cm³ g⁻¹.

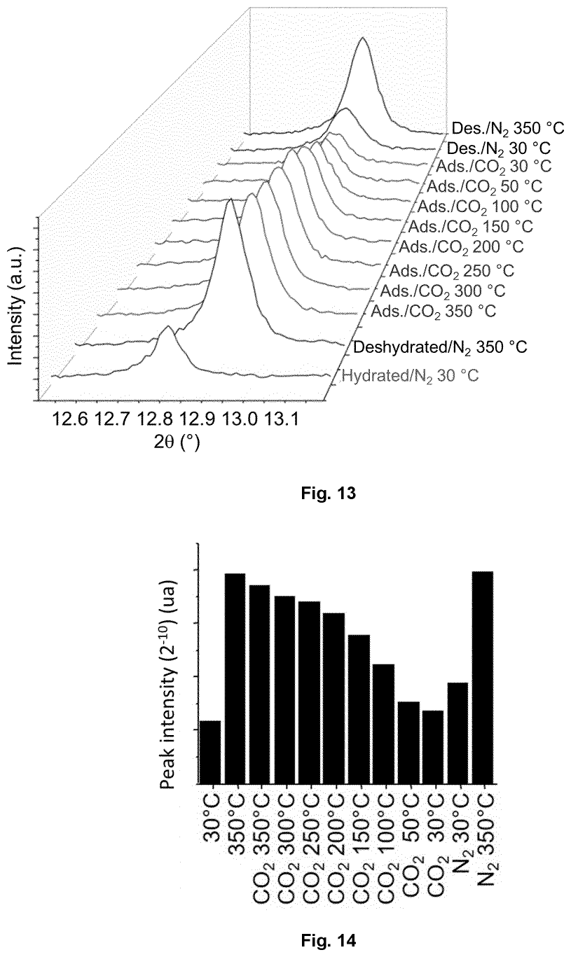

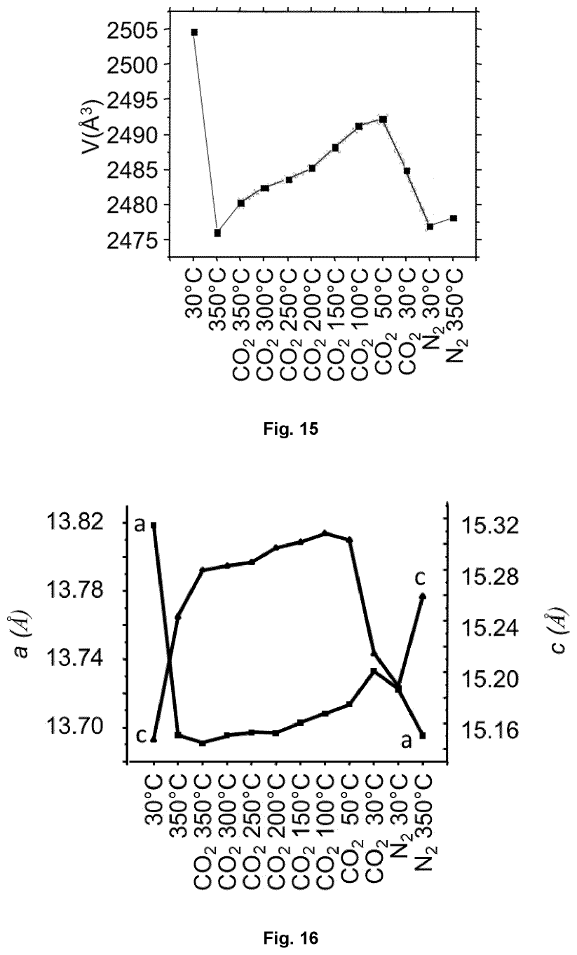

The structural determination was performed for sample 10. In situ XRD characterization of sample 10 under delivery of CO₂ was performed. The change in the intensity, position and width of the Bragg peak at 12.8° 2θ under controlled adsorption and desorption of CO₂ is presented in FIGS. 13 to 16.

The crystalline yield of samples 10 and 11 was respectively 71.2% and 70%.

### Example 3: Synthesis of Monodispersed Discrete CHA Zeolite (Samples 12-15)

An aluminate precursors aqueous suspension was prepared by dissolving 0.384 g of NaAlO₂ in 2.551 g of double-distilled H₂O. This suspension is clear. Then 1.411 g of NaOH, 0.593 g of KOH, 0.499 g of CsOH (aq. 50%) was added. As a result, a worm turbid suspension was obtained. The turbid turns into clear suspension after 10 minutes and then stirred for 2 h.

A silicate precursors aqueous suspension was prepared by dissolving 10.667 g of colloidal silica (LUDOX® HS30). This suspension is clear.

The silicate precursors aqueous suspension was added dropwise under vigorously stirring to the aluminate precursors aqueous suspension kept in ice. The weight ratio of the aluminate precursors aqueous suspension over the silicate precursors aqueous suspension is 0.7.

The resulting turbid suspension for samples 12 to 15 had the following molar compositions:

16 SiO₂:b Al₂O₃:6 Na₂O:1.35 K₂O:e Cs₂O:f H₂O

0.4≤b≤0.6;

0.15≤e≤0.25;

130≤f≤150;

This resulting turbid suspension was then mixed during 12 days at room temperature (e.g. 25° C.) under vigorous stirring (e.g. 800 rpm).

Then, the hydrothermal crystallization for CHA zeolite sample 12 was conducted at 90° C. for 2.5 hours to obtain monodisperse nanoparticles of synthetic CHA zeolite.

The hydrothermal crystallization for CHA zeolite sample 13, 14 and 15 was conducted at 90° C. for 11 hours and up to 19 hours to obtain monodisperse nanoparticles of synthetic CHA zeolite and 3% of ANA zeolite as a side-product.

Chabazite crystals were purified by three steps centrifugation (25,000 rpm for 4h) followed by redispersion in water until the decanting water reached a pH of 7, and then freeze-dried before further characterization.

The Si/Al molar ratio of the synthetic chabazite is in the range of 2.4-2.6. The prism-like crystals with the longest size between 80 nm and 120 nm in the c direction and a thickness comprised between 15 nm and 25 nm (according to the Scherrer equation of the 1s^{t} Bragg's peak) are measured. The TEM images show crystals with a size between 30 nm and 70 nm. The surface area of 121 m² g⁻¹ was determined by BET method based on N₂ adsorption measurements.

Table 7 summarizes the molar composition of the amorphous precursor mixture obtained for the samples 12-15.

TABLE 7
Molar composition of the amorphous precursor mixture obtained for
the 4 different samples prepared in accordance with example 3.

| | | | | | | | Mixing | | | |
|---|---|---|---|---|---|---|---|---|---|---|
| | | | | | | | time | Synthesis | Synthesis | |
| | SiO₂ | Na₂O | K₂O | Cs₂O | Al₂O₃ | H₂O | (days) | temperature | time | |
| 12 | 16 | 6.0 | 1.35 | 0.25 | 0.6 | 130 | 12 | 90° C. | 2.5 | h |
| 13 | 16 | 6.0 | 1.35 | 0.15 | 0.6 | 130 | 12 | 90° C. | 11 | h |
| 14 | 16 | 6.0 | 1.35 | 0.15 | 0.4 | 130 | 12 | 90° C. | 11 | h |
| 15 | 16 | 6.0 | 1.35 | 0.15 | 0.6 | 150 | 12 | 90° C. | 11 | h |

The chemical compositions and the properties of the zeolite samples 12-15 are presented in Table 8.

TABLE 8
Properties of the CHA zeolite samples 12-15.

| | | | Crystal | Specific | |
|---|---|---|---|---|---|
| | | | size | surface | CO₂ uptake |
| | Formula* | Si/Al | (nm)** | area (m²/g) | (mmol g⁻¹)*** |
| 12 | (Cs_{4.2}K_{5.3}Na_{1.1})Si_{25.4}Al_{10.6}O₇₂ | 2.5 | 87 | 12 | 4.70 |
| 13 | (Cs_{5.2}K_{4.7}Na_{0.9})Si_{25.2}Al_{10.8}O₇₂ | 2.4 | 99 | 83 | 3.80 |
| 14 | (Cs_{4.5}K_{4.9}Na_{0.8})Si_{25.8}Al_{10.2}O₇₂ | 2.6 | 119 | — | — |
| 15 | (Cs_{3.7}K_{5.4}Na_{1.1})Si_{25.8}Al_{10.2}O₇₂ | 2.6 | 90 | — | — |

*determination based on ICP analysis
**The average sizes of the crystallites in the (ab) plan were obtained from the X-Ray diffraction data using Scherrer’s equation on the reflection [2, −1, 0] using the corresponding peak at 12.82°.
***BET experiments (At 0° C., 121 kPa; Static CO₂ isotherm adsorption).

The crystalline yield of samples 12, 13, 14 and 15 was respectively 55%, 54%, 47%, and 54%.

The TEM images of sample 12 are shown in FIGS. 6C and 6D. FIGS. 3 and 4 show respectively the N₂ adsorption-desorption isotherms and the CO₂ adsorption isotherm of sample 12.

The TEM images of sample 13 are shown in FIGS. 4E and 4F.

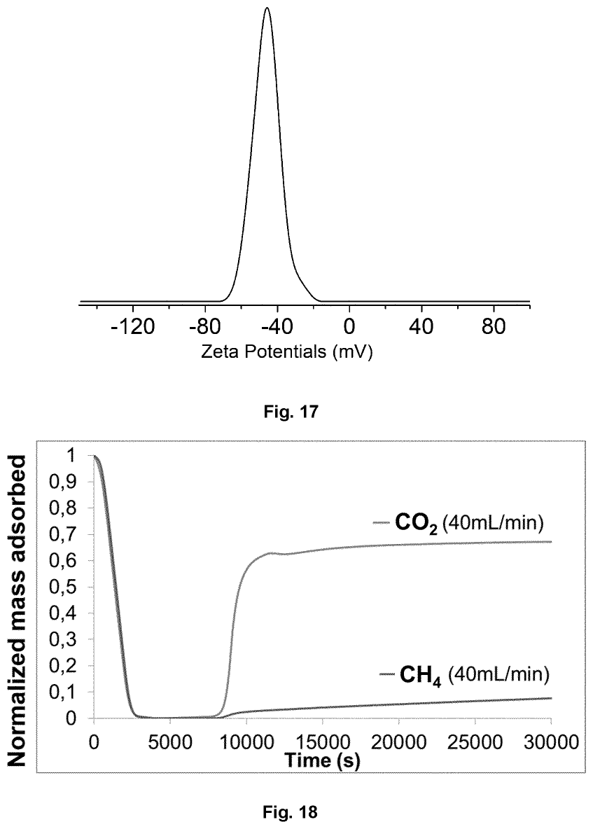

FIG. 17 shows the ζ-potential curve of sample 13 at a pH of 8 in an aqueous solution comprising 0.5 wt. % of sample 13. The ζ-potential is a key indicator of the stability of colloidal dispersion. The relatively high c-potential of sample 13 shows sample 13 is highly stable in the aqueous phase.

The as-prepared sample 13 was stable up to 800° C. The ion-exchanged sample 13 with NH₄NO₃ (following the same ion-exchange protocol as for sample 10), did not collapse after calcination (450° C., 2 h).

The normalized mass adsorption of CO₂ and CH₄ as pure gas followed by TGA experiments is shown in FIG. 18 for sample 10. After activation at 350° C. and stabilization at room temperature, the CHA-type zeolite was subjected to either pure CO₂ or pure CH₄ gas. It is observed that CHA-type zeolite has a higher capacity towards CO₂ compared to CH₄ gas. In numbers, 0.64 mmol and 2.31 mmol were absorbed per gram of CHA-type zeolite for CH₄ and CO₂ gas, respectively. Also, the rate of absorption is faster for CO₂ adsorption compared to CH₄ adsorption.

The TGA values are lower than the capacity obtained using BET isotherms (3.6 mmol/g) because TGA experiments were performed underflow and at 25° C. while BET experiments were performed at 0° C. under static conditions.

### Example 4: Advantage of Potassium and Caesium

A zeolite comprising caesium and potassium (sample 16) was prepared from the following molar composition:

10 SiO₂:0.8 Al₂O₃:8 Na₂O:0.6 Cs₂O:1.25 K₂O:110 H₂O

The template-free of nanosized zeolite without KOH was prepared from the precursor suspension having the following molar composition:

10 SiO₂:0.8 Al₂O₃:8 Na₂O:0.6 Cs₂O:110 H₂O

The suspension was aged at room temperature for 20 h under stirring. The hydrothermal treatment was performed at 90° C. for 7 hours to afford sample 17.

The template-free of nanosized zeolite without CsOH was prepared from a precursor solution having the following molar composition:

10 SiO₂:0.8 Al₂O₃:8 Na₂O:1.25 K₂O:110 H₂O

The suspension was aged at room temperature for 20 h under stirring. The hydrothermal treatment was performed at 90° C. for 7 hours, according to the study entitled “Location of alkali ions and their relevance to the crystallization of low silica X zeolite” of Iwama M. et al. (Cryst. Growth Des., 2010, 10, 3471-3479). Sample 18 is thus obtained.

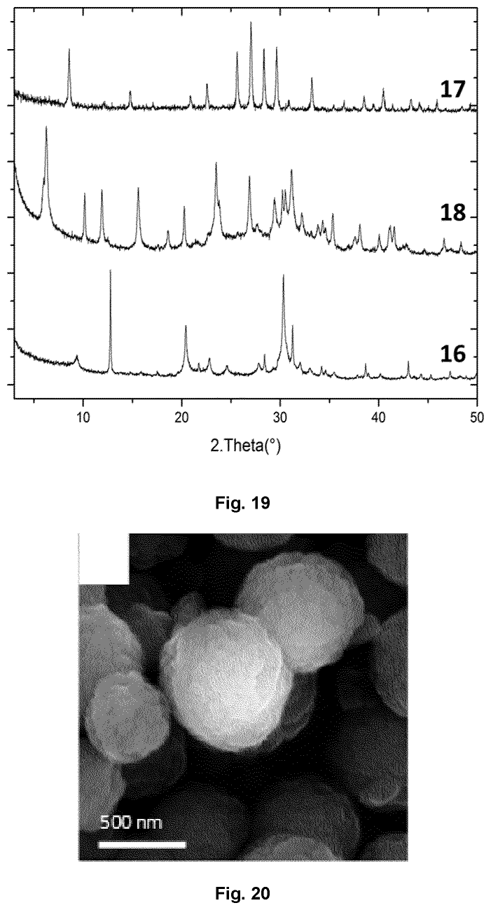

FIG. 19 shows the XRD pattern of the as-prepared material. While sample 16 is the pattern of a chabazite-type zeolite, sample 17 is the pattern that corresponds to pure RHO zeolite and sample 18 is a pattern that corresponds to an FAU zeolite with EMT as a secondary phase.

Using ICP analysis, the Si/Al ratio of samples 17 and 18 has been determined to be of 1.4.

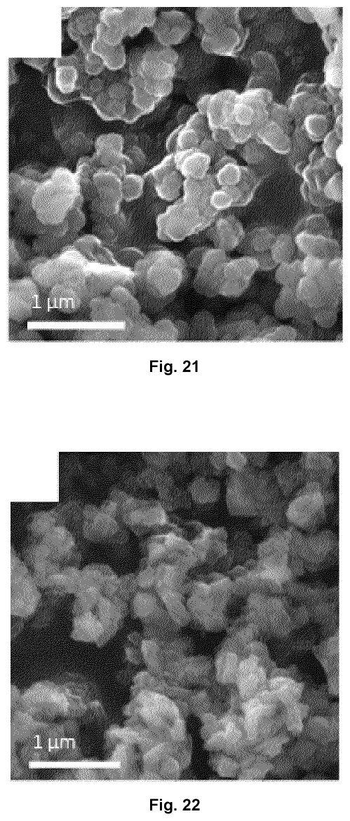

FIG. 20 shows the SEM image of sample 16, corresponding to a CHA zeolite. It shows aggregates of the size of 800 nm with individual crystallites with a size ranging between 30 nm and 100 nm. FIGS. 21 and 22 respectively show the SEM images of samples 17 and 18, which are respectively a sample of RHO zeolite and FAU zeolite. FIGS. 21 and 22 show that individual crystallites have a size ranging between 50 nm and 200 nm.

Table 9 summarizes the synthesis conditions and the phases that were obtained.

TABLE 9
Conditions and results of the zeolite preparation

| | | | | | | | Synthesis | Synthesis | Phase |
|---|---|---|---|---|---|---|---|---|---|
| | SiO₂ | Na₂O | K₂O | Cs₂O | Al₂O₃ | H₂O | temperature | time | obtained |
| 16 | 10 | 8.0 | 1.25 | 0.60 | 0.80 | 110 | 90° C. | 7 h | CHA |
| 17 | 10 | 8.0 | 0 | 0.60 | 0.80 | 110 | 90° C. | 7 h | RHO |
| 18 | 10 | 8.0 | 1.25 | 0 | 0.80 | 110 | 90° C. | 7 h | FAU + |
| | | | | | | | | | (EMT) |

1. A chabazite-type zeolite, comprising at least two cages composed of 4- and 8-membered rings connected by one 6-membered double ring, characterized by having a Si/Al molar ratio comprised between 1 and 15 as determined by ²⁹Si magic angle spinning nuclear magnetic resonance, said chabazite-type zeolite comprises caesium and potassium with a Cs/K molar ratio of at most 5.0 as determined by Inductively Coupled Plasma Optical Emission Spectrometry; and said chabazite-type zeolite forming nanoparticles with an average crystal size comprised between 5 nm and 250 nm as determined by the Scherrer equation and with a specific surface area comprised between 50 m² g⁻¹ and 200 m² g⁻¹, as determined by N₂ sorption measurements.

2. The chabazite-type zeolite according to claim 1, characterized in that said nanoparticles have a pore volume comprised between 0.10 cm³ g⁻¹ and 0.50 cm³ g⁻¹, as determined by N₂ sorption measurements.

3. (canceled)

4. The chabazite-type zeolite according to claim 1, characterized in that said chabazite-type zeolite has an M¹/Al molar ratio ranging from 0.02 to 0.20, as determined by Inductively Coupled Plasma Optical Emission Spectrometry wherein M¹ is selected from Na and/or Li; preferably from 0.05 to 0.15; more preferably from 0.075 and 0.12.

5. The chabazite-type zeolite according to claim 1, characterized in that said chabazite-type zeolite has an M¹/Cs molar ratio ranging from 0.10 to 0.50, as determined by Inductively Coupled Plasma Optical Emission Spectrometry wherein M¹ is selected from Na and/or Li; preferably from 0.14 to 0.40; more preferably from 0.17 and 0.30.

6. The chabazite-type zeolite according to claim 1, characterized in that the Si/Al molar ratio as determined by ²⁹Si magic angle spinning nuclear magnetic resonance is at least 1.5; preferably at least 2.1.

7. The chabazite-type zeolite according to claim 1, characterized in that the Si/Al molar ratio as determined by ²⁹Si magic angle spinning nuclear magnetic resonance is at most 5, preferably at most 3.0.

8. (canceled)

9. The chabazite-type zeolite according to claim 1, characterized in that the Cs/K molar ratio is at least 0.1 as determined by Inductively Coupled Plasma Optical Emission Spectrometry; preferably at least 0.3; more preferably at least 0.5.

10. The chabazite-type zeolite according to claim 1, characterized in that said chabazite-type zeolite has a Cs/Al molar ratio comprised between 0.15 and 0.45 as determined by Inductively Coupled Plasma Optical Emission Spectrometry, preferably between 0.20 and 0.40, more preferably between 0.22 and 0.38.

11. (canceled)

12. An amorphous precursor of chabazite-type zeolite for the preparation of a chabazite-type zeolite according to claim 1, characterized in that said amorphous precursor of chabazite-type zeolite has a molar composition comprising
a SiO₂:b Al₂O₃:c M¹₂O:d K₂O:e Cs₂O:f H₂O,
wherein a, b, c, d, e, and f are coefficients, wherein
the coefficient a is ranging from at least 10.0 and at most 20.0;
the coefficient b is ranging from at least 0.3 and at most 2.5;
the coefficient c is ranging from at least 5.0 and at most 11.0;
the coefficient d is ranging from at least 0.7 and at most 1.6;
the coefficient e is ranging from at least 0.05 and at most 0.60; and
the coefficient f is ranging from at least 60 and at most 200
wherein M¹₂O is selected from Na₂O and/or Li₂O.

13. The amorphous precursor of claim 12, characterized in that the coefficient a is ranging from at least 10.0 and at most 16.0; and/or the coefficient b is ranging from at least 0.5 and at most 1.5.

14. The amorphous precursor of claim 12, characterized in that the coefficient c is ranging from at least 6.0 and at most 10.0; and/or the coefficient d is ranging from at least 0.8 and at most 1.6.

15. The amorphous precursor of claim 12, characterized in that the coefficient e is ranging from at least 0.15 and at most 0.45 and/or the coefficient f is at least 80 and at most 190; preferably at least 90 and at most 160.

16. The amorphous precursor of claim 12, characterized in that the (M¹₂O+Cs₂O+K₂O)/SiO₂ ratio is at least 0.55 wherein M¹ is selected from Na and/or Li, preferably is ranging from 0.55 to 1.00; more preferably from 0.58 to 0.95 and even more preferably from 0.60 to 0.90.

17. The amorphous precursor of claim 12, characterized in that the ratio M¹₂O/H₂O is superior or equal to 0.03, preferably superior or equal to 0.04, more preferably superior or equal to 0.05.

18. The amorphous precursor of claim 12, characterized in that the ratio M¹₂O/Al₂O₃ is superior or equal to 7.0, preferably superior or equal to 7.5.

19. The amorphous precursor of claim 12, characterized in that the ratio Cs₂O /Al₂O₃ is inferior or equal to 0.80, preferably inferior or equal to 0.60.

20. Method for the preparation of an amorphous precursor of a chabazite-type zeolite as defined in claim 12, comprising the following steps:
a) providing an aluminate precursors aqueous suspension;
b) providing a silicate precursors aqueous suspension;
c) adding at least three metallic precursors in the said aluminate precursors aqueous suspension to form a first aqueous suspension, wherein the at least three metallic precursors comprises caesium hydroxide, potassium hydroxide and at least one selected from sodium hydroxide and/or lithium hydroxide;
d) forming an amorphous precursor of zeolite by adding dropwise the silicate precursors aqueous suspension into said first aqueous suspension;
with preference, the at least three metallic precursors comprise caesium hydroxide, potassium hydroxide and sodium hydroxide.

21. (canceled)

22. Method for the preparation of an amorphous precursor of a chabazite-type zeolite as defined in claim 12, comprising the following steps:
a) providing an aluminate precursors aqueous suspension;
b) providing a silicate precursors aqueous suspension;
c) adding at least three metallic precursors in the said silicate precursors aqueous suspension to form a second aqueous suspension, wherein the at least three metallic precursors comprise caesium hydroxide, potassium hydroxide and at least one selected from sodium hydroxide and/or lithium hydroxide;
d) forming an amorphous precursor of zeolite by adding dropwise the aluminate precursors aqueous suspension into said second aqueous suspension;
with preference, the at least three metallic precursors comprise caesium hydroxide, potassium hydroxide and sodium hydroxide.

23. (canceled)

24. Method for the preparation of an amorphous precursor of a chabazite-type zeolite as defined in claim 12, comprising the following steps,
a) providing an aluminate precursors aqueous suspension;
b) providing a silicate precursors aqueous suspension;
c) adding at least three metallic precursors in the said aluminate precursors aqueous suspension to form a first aqueous suspension and in the said silicate precursors aqueous suspension to form a second aqueous suspension, wherein the at least three metallic precursors comprise caesium hydroxide, potassium hydroxide and at least one selected from sodium hydroxide and/or lithium hydroxide;
d) forming an amorphous precursor of zeolite by adding dropwise the said first aqueous suspension into said second aqueous suspension or by adding dropwise the said second aqueous suspension into said first aqueous suspension;
with preference, the at least three metallic precursors comprise caesium hydroxide, potassium hydroxide and sodium hydroxide.

25. (canceled)

26. (canceled)

27. Method for the preparation of a chabazite-type zeolite as defined in claim 1, comprising the method for the preparation of an amorphous precursor of a chabazite-type zeolite according to claim 20 and further comprising the following steps:
e) mixing the amorphous precursor according to claim 12 under stirring and/or orbital shaking;
f) optionally, adding an additional silicate precursors aqueous suspension and mixing said amorphous precursor under stirring and/or orbital shaking;
g) heating said amorphous precursor at a temperature comprised between 90° C. and 160° C. such as to form one or more crystals of chabazite-type zeolite;
h) cooling down said one or more crystals of chabazite-type zeolite at a temperature comprised between 20° C. and 25° C.,
i) dispersing said one or more crystals of chabazite-type zeolite in water,
j) optionally, recovering said one or more crystals of chabazite-type zeolite.

28.-30. (canceled)
